(19) United States
(12) Patent Application Publication
(10) Pub. No.: US 2016/0269984 A1
(43) Pub. Date: Sep. 15, 2016

(54) PROXIMITY RECOGNITION SYSTEM

(71) Applicants: James Francis Hallett, Vancouver (CA); Kirk Arnold Moir, New Westminster (CA)

(72) Inventors: James Francis Hallett, Vancouver (CA); Kirk Arnold Moir, New Westminster (CA)

(73) Assignee: Locality Systems Inc., Burnaby (CA)

(21) Appl. No.: 15/161,132

(22) Filed: May 20, 2016

Related U.S. Application Data
(63) Continuation-in-part of application No. 14/104,417, filed on Dec. 12, 2013, now Pat. No. 9,392,409.

(51) Int. Cl. H04W 48/16; H04W 76/02; H04W 4/02

(52) U.S. Cl. CPC H04W 48/16; H04W 4/025; H04W 76/02; H04W 84/12

(57) ABSTRACT

Disclosed is an invention for the identification of the true identity of a WLAN device that has been “cloaked” (its source address has the U/L bit set as L), by evaluating its history (recent or distant) of Probe requests for WLAN infrastructure and treating that history as part of its “fingerprint”. Disclosed also is an invention that prompts more management frames from a WLAN device that is sending broadcast Probe requests without specifying a particular network, by presenting the appearance of the presence of popular networks.

### CROSS-REFERENCES TO RELATED APPLICATIONS

This application is a continuation-in-art application and claims priority from Provisional U.S. patent application Ser. No. 61/737,097 (filed Dec. 13, 2012); U.S. patent application Ser. No. 14/104,417 (filed Dec. 12, 2013); U.S. patent application Ser. No. 61/974,976 (filed Apr. 3, 2014); and U.S. patent application Ser. No. 14/556,034 (filed Nov. 28, 2014); the respective disclosures of which are incorporated herein, in their entireties, by reference for all purposes.

### BACKGROUND OF INVENTION

1. Field of Invention

The present invention relates to proximity detection and recognition of WLAN and related enabled mobile devices.

2. Description of Related Art

Understanding visitor behavior is critical to the design and optimization of retail and public spaces. Visitor behavior information is valuable to both owner/operator of the space, venue or real estate as well as the merchants operating therein.

Adoption of mobile devices including mobile phones, smart phones, and tablets has enabled new means of allowing consumers to interact with merchants. Consumers can announce their presence as well as their interest in specific offers from the merchants they are visiting or are considering visiting. Merchants can also use mobile devices to better understand customer behavior and better incent customers.

Mobile devices are typically aware of their location thanks to technologies such as the global positioning system (GPS) and can provide this information to both software applications as well as the mobile communication network itself. GPS requires the mobile device to have a clear view of the sky in order to receive positioning information from multiple GPS satellites which are typically deployed above the equator in geosynchronous orbit. Because of this, GPS does not work well indoors or in outdoor locations that have obscured access to the portion of the sky where GPS satellites appear. This includes outdoor locations with tall buildings or other large infrastructure such as bridges (referred to as “urban canyons”) and areas with dense foliage.

Mobile communications networks also have extensive positioning capabilities. Terrestrial based mobile communications network deploy a large number of base stations. The design of mobile communications networks has the mobile device stay in constant association with one or more base stations. As a result, the mobile communications network has information about the macro location of a mobile device. The range of a base station can be several miles in diameter and accurate positioning is made difficult due to signal strength fluctuations and other technical challenges.

Newer systems such as “Assisted GPS” are designed to combine information from GPS and mobile communications networks to improve accuracy. These systems also suffer from accuracy problems when GPS coverage is lost for extended periods of time.

Alternatives to satellite based location systems are emerging. One such example involves frequently sensing and recording the identification (typically by MAC address) and the signal strength of all the 802.11 based WiFi access points at a specific location. This recording is typically performed with a specially designed vehicle. When a mobile device needs to know its position, the mobile device itself can sense all the 802.11 access points in its vicinity and compare this with the previously recorded information to determine its location. This approach is effective in urban locations where GPS does not perform well. Increased AP (“Access Point”) density and frequent recording increase the accuracy of this type of system. These kinds of systems also operate independently of the mobile communications network. Once location is determined at the mobile device, it can be used by software applications on the mobile device to, for example, display location on a map background or it can be reported to a central server via the Internet.

A key consideration for merchants is the enablement and measurement of loyalty. Various techniques and technologies exist to perform this function. In order to attract customers and transaction traffic, merchants offer various transaction based incentive programs either developed internally or offered by a related third party provider. These incentive programs typically provide some credits or points which are provided proportionally to the size of the transaction. Some incentive programs may provide time limited programs where more points are assigned for purchasing a certain kind of good or service or purchasing at a certain class of merchant. Wide varieties of other incentive schemes exist or are possible.

Various systems exist to furnish information to merchants related to visitor behavior in retail and public spaces. These include thermal cameras, stereoscopic video cameras, and infrared light beams as well as other more application specific technologies such as road induction loops.

Such systems lack the ability to accurately detect and report on behavior of visitors between visits to a venue. This is an active area of innovation. Innovations in camera technology including facial recognition are being actively pursued by several parties.

To improve real estate provider and merchant understanding of the visitors to their premises, an improved system would be useful for enabling better understanding of the behavior of customers including visit frequency and visit duration with mobile devices.

One solution is to provide a system for receiving information transmitted by mobile devices in unlicensed spectrum and inferring behavior from this information including overall arrival rate, average length of visit, average frequency of visit, and, where possible, cross reference with loyalty related information.

### SUMMARY OF THE INVENTION

The present invention integrates proximity recognition of mobile devices with customer behavior analytics.

Customer behavior is an important indicator of how successfully a company's marketing, branding, advertising as well as store formatting and arrangement are at bringing people into the actual merchant venue. Depending on the type of retailer, conversion rates from venue visits to actual purchases in the physical retail world are typically between 20-60%.

It is an object of the present invention to provide new and improved systems and process which preferably utilize technologies that enable merchants to better understand customer behavior. Customer behavior can be characterized in terms of both overall visitor statistics (such as unique visitors in a given time period such as an hour, day, or week) as well as additional measurements of behavior such as visit duration including related trending such as average customer visit, visitor return frequency and related trending, as well as visitor location and path taken within the venue. Customers can be classified for subsequent analysis. One example of this would be to classify customers according to their return frequency. Customer behavior can also be determined relative to specific time period at a venue when, for example, an event is held to determine, for example, absolute number and percent of visitors visiting the venue for the first time as well as the rate at which all visitors in a given category of visitors (such as first time visitors) return to the venue.

In accordance with the present invention, there is provided a system and process which enables a merchant operating in one or more venues to effectively understand the behavior of customer with WLAN enabled mobile devices.

Accordingly, one aspect of the present invention enables the merchant or real estate provider to become registered with the proximity recognition system (“PRS”) through some online application process, some preexisting registration or sales fulfillment process including potentially preexisting offline processes or some combination of all of these possible process configurations.

Accordingly, the present invention involves one or more proximity recognition devices (or PRDs) operating at a merchant venue. Interactions between mobile devices and WLAN infrastructure are recorded by the proximity recognition device PRD, analyzed and sent to the central controller. Knowledge of interactions with mobile devices provides the proximity recognition system (PRS) with the ability to detect presence and specific location of the mobile device (i.e. its associated visitor) within the venue. As visitors move through the venue, the proximity recognition system (PRS) may emulate WLAN infrastructure of interest to the mobile device by prompting such interaction.

Accordingly, the present invention involves improvement of location accuracy. As location accuracy improves with the amount of interaction (between mobile devices and the system's PRD) to analyze, the PRD may optionally be tuned to prompt more or less interaction with the mobile device based on the objectives of the venue operator.

Accordingly, the present invention involves improvement of location accuracy through common trilateration techniques on interaction data received from three or more in venue receiver units.

Accordingly, the present invention involves analysis of the venue's current or future wireless local area network as, in some venues, such as sports venues, quality performance of the wireless local area network is becoming a required aspect of a customer's visit.

Accordingly, the present invention's central controller of the proximity recognition system (PRS), in one embodiment, is designed to run as an Internet connected appliance providing a cloud based service. Alternative embodiments enable the central controller to be run by a merchant, a collection of merchants, or by a third party providing new or existing merchant analytics service including “footfall” analytics. When the customer enters a specific merchant venue, the system recognizes the event based on the detection of the customer's WLAN enabled mobile device. Customer behavior such as path taken through the venue and visit duration is reported to the central controller for appropriately anonymized analysis by the merchant's staff.

Accordingly, the present invention involves analysis by the central controller of information received from a plurality of proximity recognition devices PRDs deployed in venues connected to the central controller by a communications network such as the Internet. Results of this analysis are then transmitted to or available for display to the merchant or real estate provider at their request.

Accordingly, the present invention involves correlation with one or more loyalty incentive systems operated by the merchant or the real estate provider and presenting the results of this correlation analysis to the merchant or real estate provider at their request and/or optionally back to the loyalty incentive system.

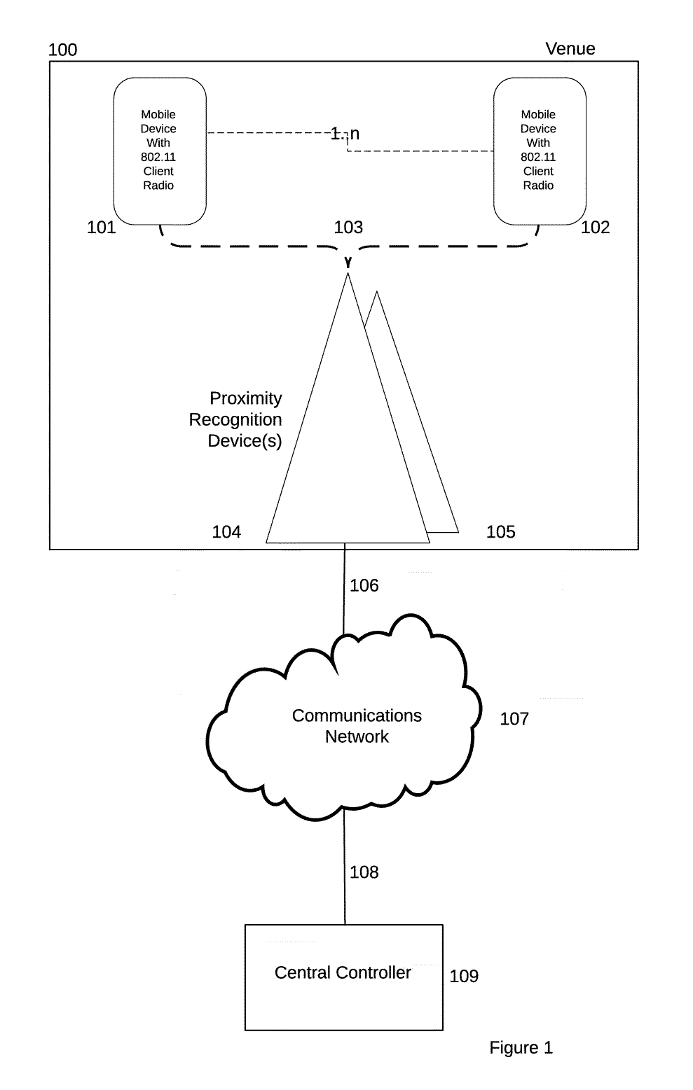

FIG. 1 illustrates the system architecture of the proximity recognition system (PRS).

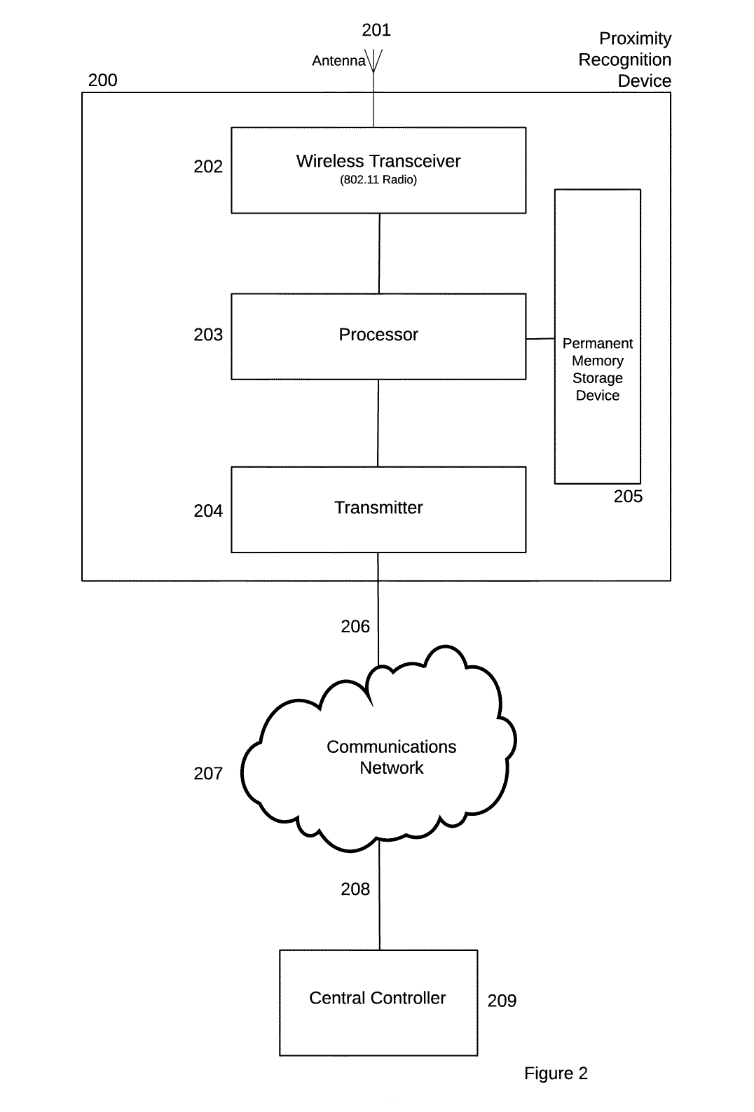

FIG. 2 is a functional block diagram of a proximity recognition device (PRD).

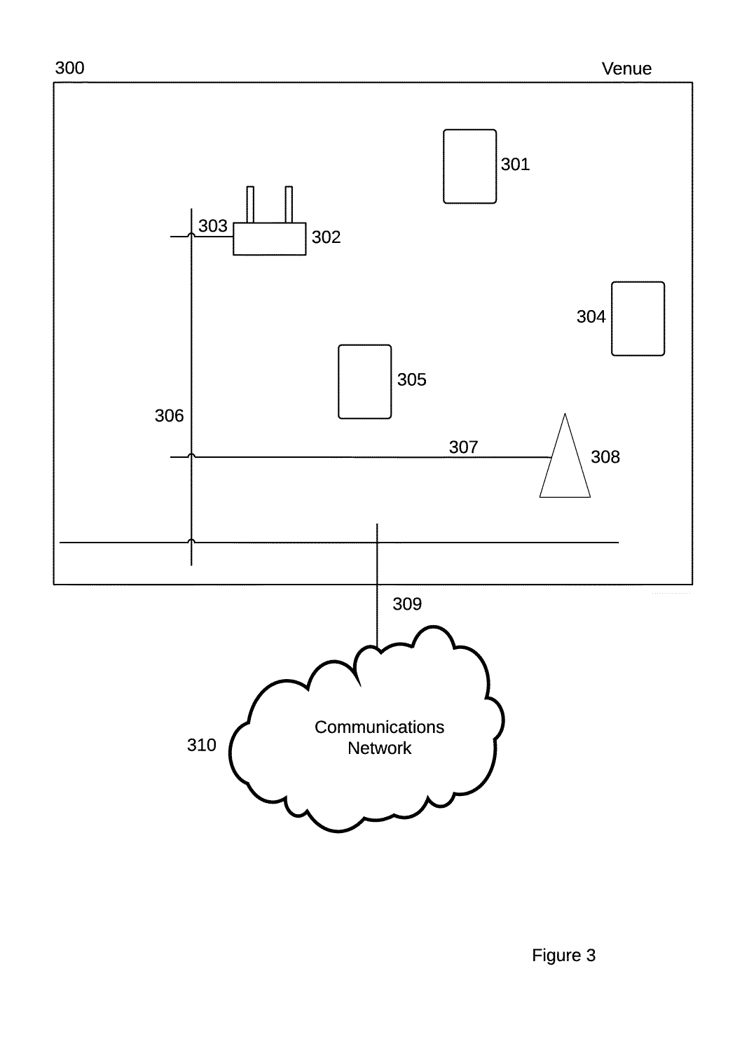

FIG. 3 illustrates communications between the mobile device, possible access points in the vicinity and a proximity recognition device (PRD).

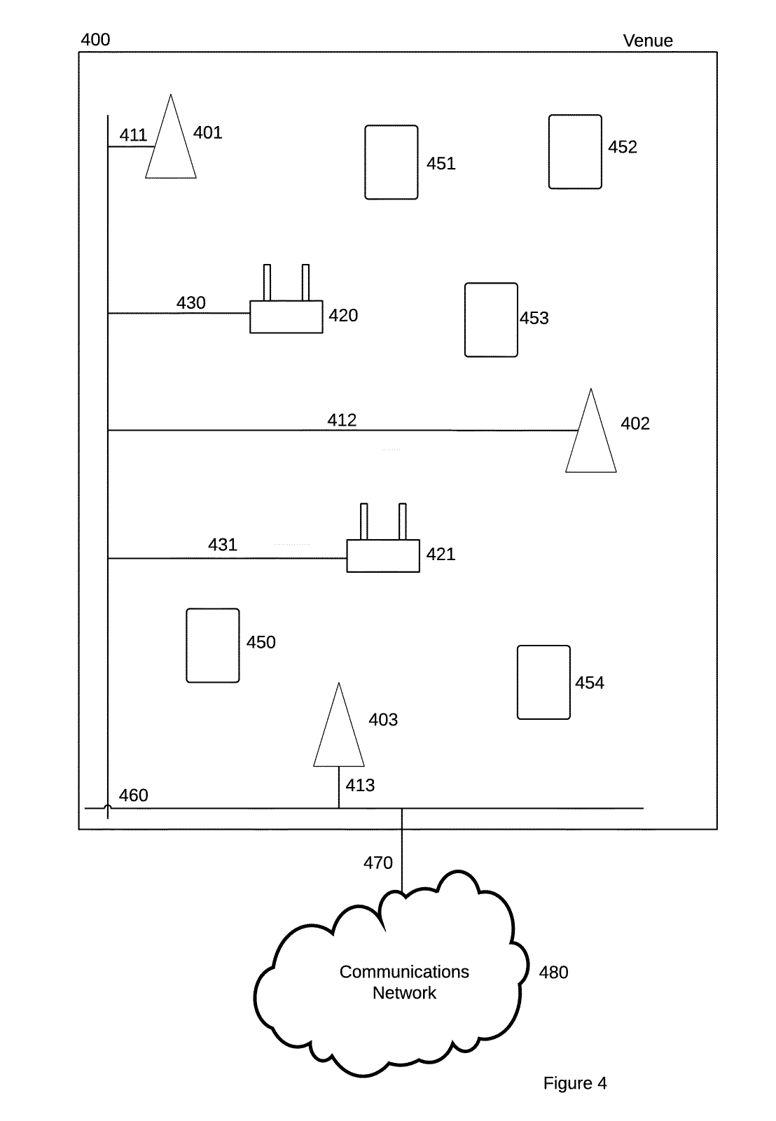

FIG. 4 illustrates communications between the mobile device, possible access points in the vicinity and plurality of proximity recognition devices (PRDs).

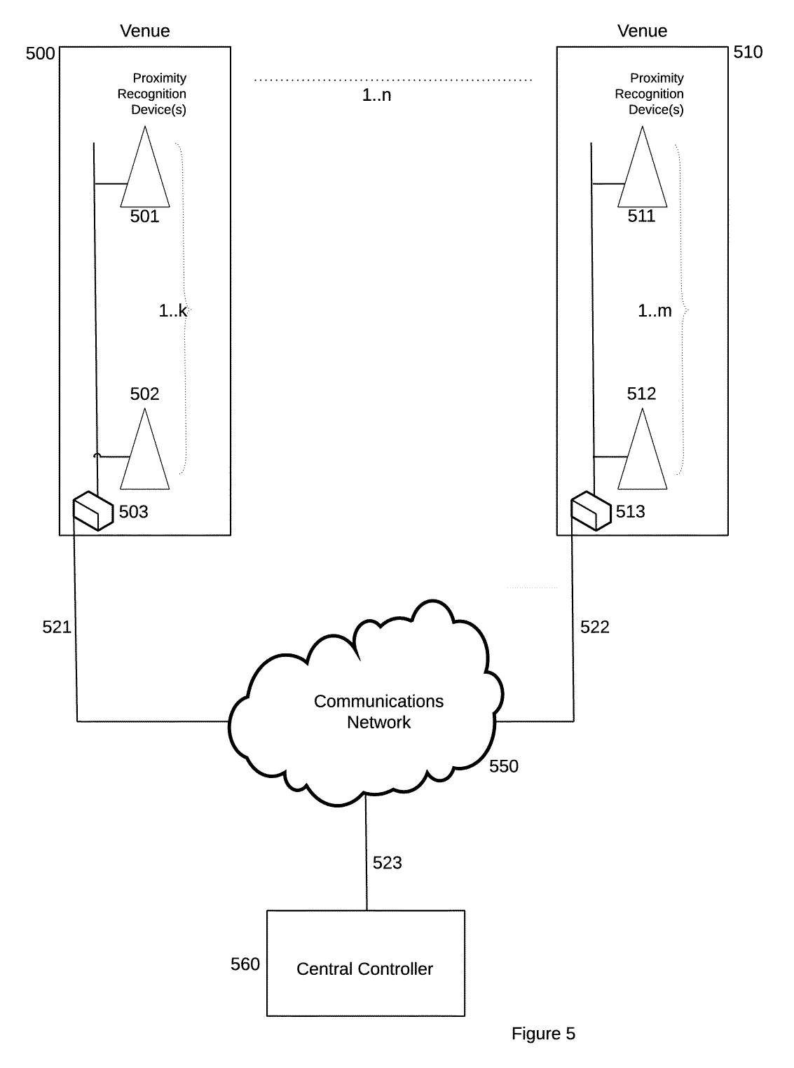

FIG. 5 is an architecture drawing of a distributed proximity recognition system (PRS) including PRD units and a central controller.

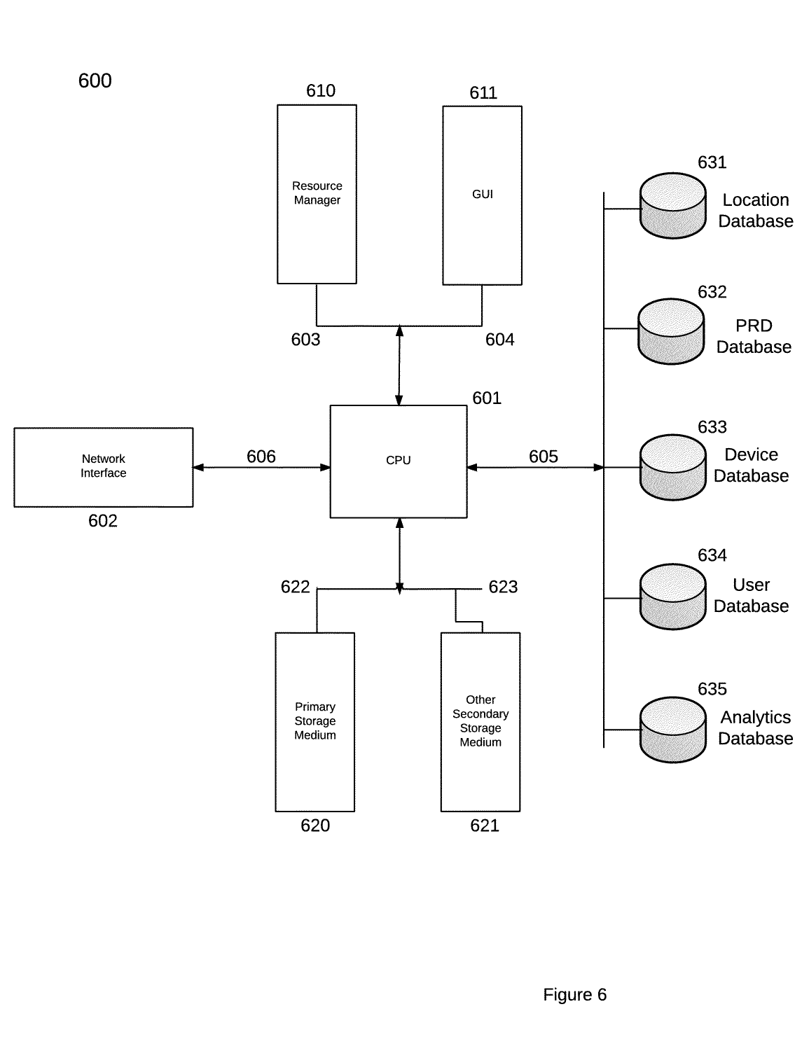

FIG. 6 is a block diagram of the central controller.

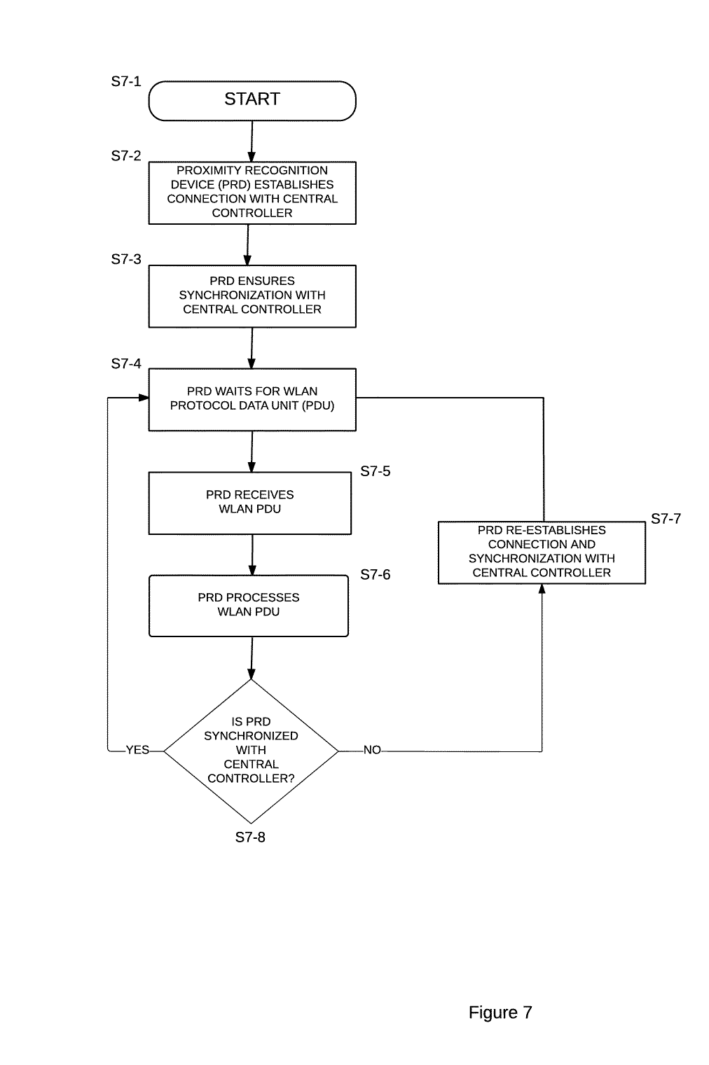

FIG. 7 is a logic diagram illustrating the process of a proximity recognition device (PRD) operating in the vicinity of an accessible access point (AP).

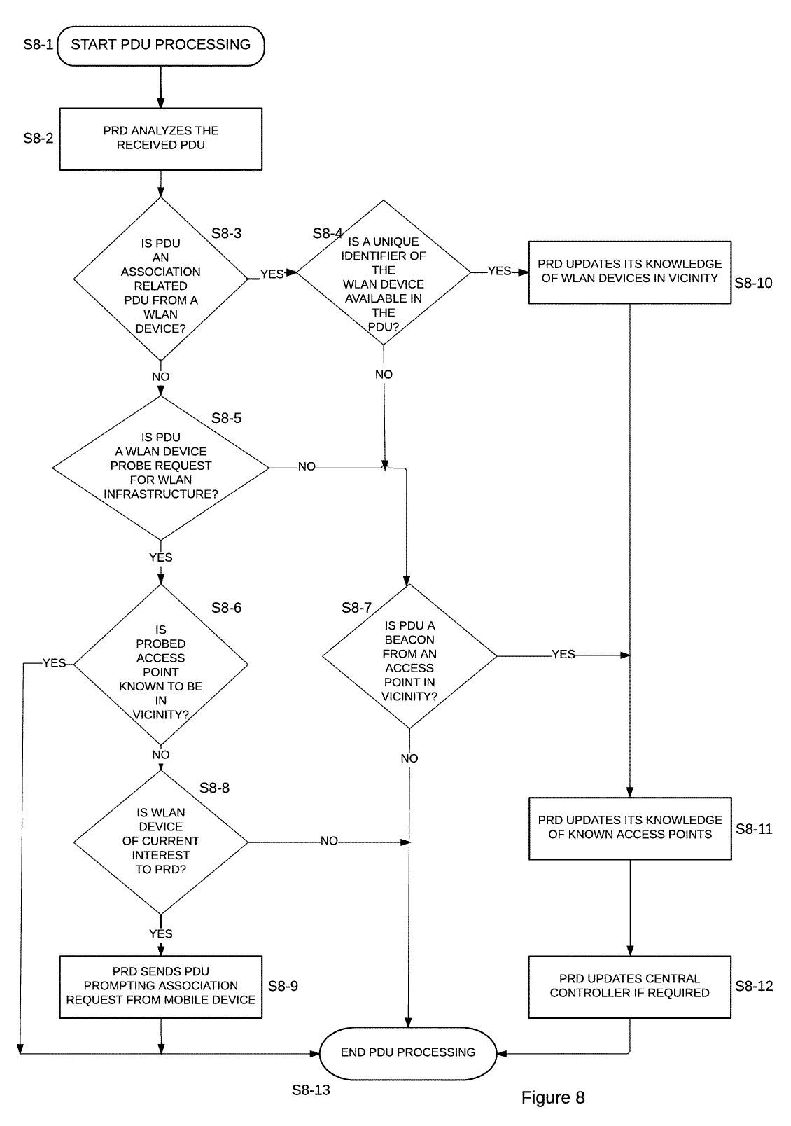

FIG. 8 is a logic diagram illustrating the process of a proximity recognition device (PRD) operating with no accessible access points (APs) in the vicinity.

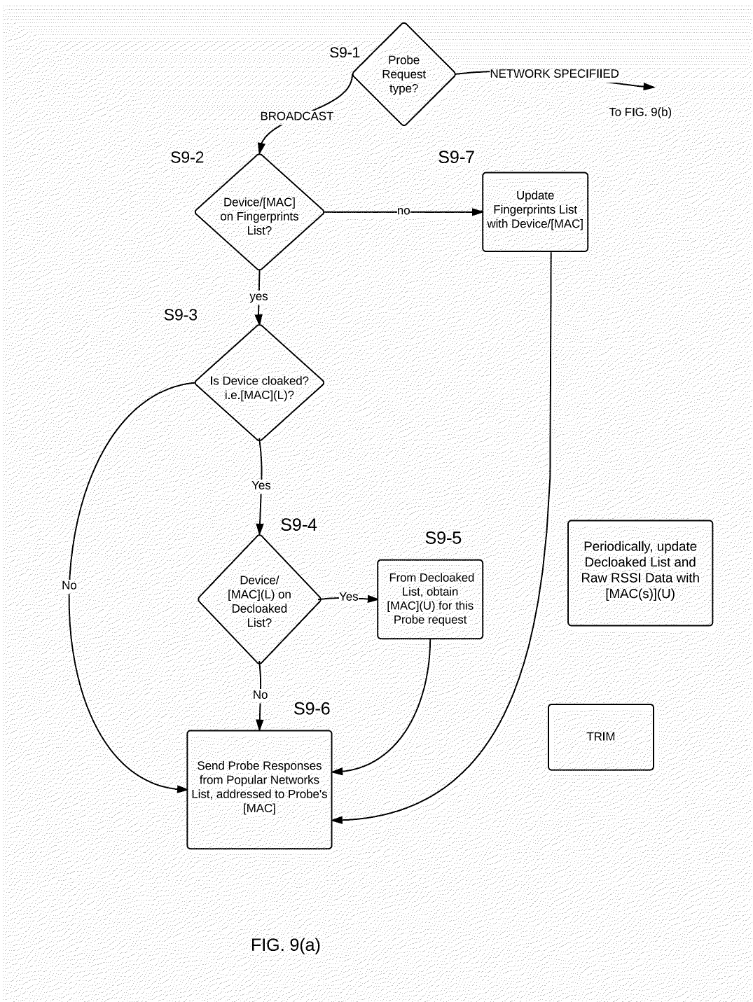

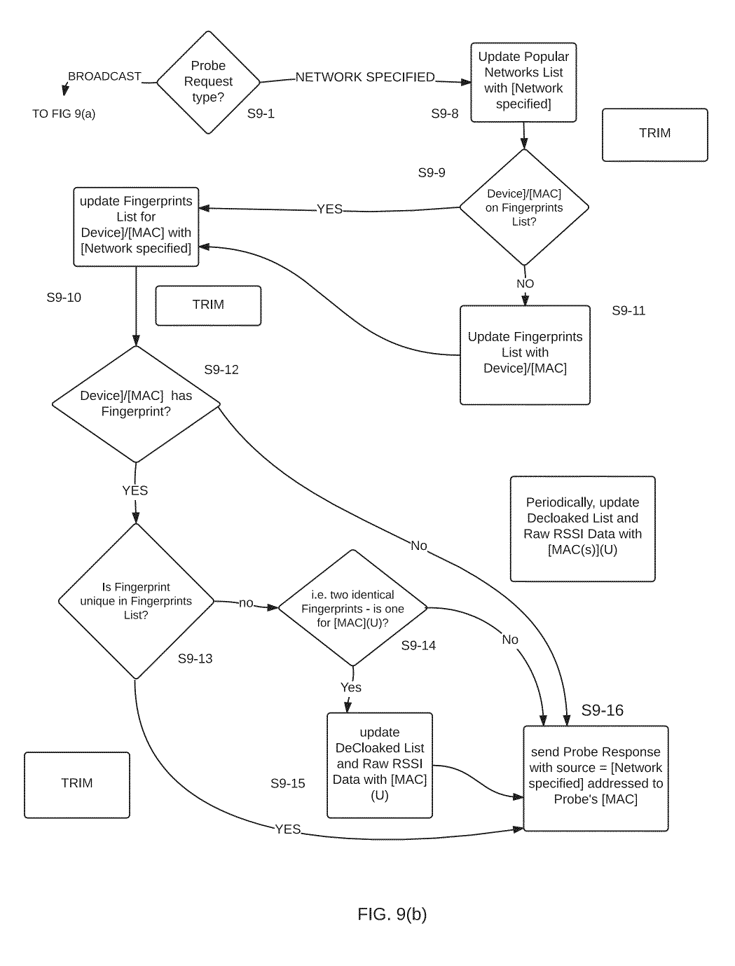

FIGS. 9(a) and 9(b) are logic flow diagrams illustrating the process of a probe request.

In this section, the present invention is described in detail with regard to the drawing figures briefly described above.

For purposes of description the following terms have these meanings:

The terms “real estate provider”, “venue owner”, “venue operator”, “real estate operator” and “real estate owner” unless otherwise specified below are used interchangeably to refer to the entity that owns and/or operates real estate space. Real estate providers in the context of the present invention are interested in one or both of the following objectives: understand behavior of visitors to their owned and/or operated space and enable merchants operating in the owned and/or operated space to understand behavior of visitors and potential customers.

The terms “venue”, “premise”, “space”, “real estate”, and “real estate premise” unless otherwise specified below are used interchangeably to refer to a specific physical space owned and/or operated by a real estate provider. Venues include malls, stores, shops, and theatres as well as other types of spaces including hotels, motels, inns, airports, dock facilities, arenas, hospitals, schools, colleges, universities, libraries, galleries, stations, parks, and stadiums. In alternate embodiments of the invention, space may include roadways on which vehicles operate.

The terms “WiFi, “Wifi”, “WLAN”, “Wireless Fidelity”, and “wireless local area network” all refer to communications between mobile devices and infrastructure elements (commonly referred to as “access points” or APs). WLAN refers to devices and infrastructure using some variant of the 802.11 protocol defined by the Institute of Electrical and Electronics Engineers (IEEE) or some future derivation.

The terms “mobile device”, “wireless device”, “wireless local area enabled device”, “WiFi mobile device” and “WLAN device” all refer to devices equipped to communicate over a wireless local area network in accordance with the 802.11 protocol, wherein the subject device initiates an association process with relevant infrastructure elements by undergoing the sequential phases of (1) scanning, (2) authentication (optional in some deployments) and (3) association. These phases involve the sending, receiving and processing of management frames. The scanning phase involves management frames related to probes and Beacons, amongst others; the authentication phase involves authentication and de-authentication frames; and the association phase involves association request and association response frames.

The terms “merchant”, “store”, “outlet”, and “retailer” unless otherwise specified below are used interchangeably to refer to any type of location that sells goods or services. A merchant may also own all or a portion of the space in which they operate.

The terms “customer”, “buyer”, and “consumer” unless otherwise specified below, are used interchangeably to refer to any party that visits a venue and who may initiate a purchase of a good or a service.

The terms “visitor”, “guest, or “invitee” unless otherwise specified below, are used interchangeably to refer to any party that visits a venue which may or may not house merchants with whom a visitor could initiate a purchase of a good or service.

The above defined terms are used to describe the preferred embodiment of the present invention in reference to the attached drawing figures. Where appropriate, parts are referred to with reference numerals.

Referring to FIG. 1, the principal components used to implement the present invention are illustrated in a block diagram. A system and method is provided for proximity detection, recognition and classification of a wireless local area network (WLAN) enabled device without a WLAN infrastructure (APs). The proximity recognition system (PRS) monitors WLAN communications at one or more known locations depicted in FIG. 1 as 100. The proximity of a WLAN mobile device 101 or plurality of WLAN mobile devices 101, 102 is sensed by examining signal strength at a proximity recognition device PRD 104, 105 when the WLAN mobile device 101 initiates an association request for WLAN access. An identifier of the WLAN mobile device may be provided in the association request. Association requests may be periodic or may be prompted by a specific response from the proximity recognition device PRD 104 which may operate on one or a plurality of WLAN channels. Association requests may be sensed by one or a plurality of proximity recognition devices PRDs 104, 105. Information received by the proximity recognition devices PRDs is analyzed, summarized and sent via communications interface 106 comprising some combination of cable modems, DSL, DS1, DS3, SONET, Ethernet, fiber optic, WiMax, WiFi 802.11 or other wireless technology such as CDMA, GSM or long term evolution (LTE) or other future communications capability to a communications network 107 such as the Internet. Central Controller 109 of the proximity recognition system PRS is connected to the same communications network 107 via communications interface 108.

It should be appreciated that the present invention can be implemented in numerous ways, including as a process, a system, an apparatus, a device, a method, a computer readable storage medium containing computer program code, or as a computer program product comprising a computer usable medium having a computer readable program code embodied therein.

In the present context, a computer usable medium or computer readable medium may be any medium that can contain or store the program for use by or in connection with the instruction execution system, apparatus or device. For example, the computer readable storage medium or computer usable medium may be, but is not limited to, a random access memory (RAM), read-only memory (ROM), or a persistent store, such as a mass storage device, hard drives, CDROM, DVDROM, solid state drives, tape, erasable programmable read-only memory (EPROM or flash memory), or any magnetic, electromagnetic, infrared, optical, or electrical system, apparatus or device for storing information. Alternatively or additionally, the computer readable storage medium or computer usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory.

Applications, software programs or computer readable instructions may be referred to as components or modules. Applications may be hard coded in hardware or take the form of software executing on a general purpose computer such that when the software is loaded into and/or executed by the computer, the computer becomes an apparatus for practicing the invention, or they are available via a web service. Applications may also be downloaded in whole or in part through the use of various development tools which enable the creation, implementation of the present invention. In this specification, these implementations, or any other form that the invention may take, may be referred to as techniques. In general, the order of the steps of disclosed processes may be altered within the scope of the invention.

With reference to FIG. 2, a block diagram of a proximity recognition device (PRD) is presented.

PRD 200 has one or more a wireless antennas 201 for receiving signals from WLAN equipped mobile devices in the vicinity of PRD 200.

PRD 200 is equipped with a WLAN capable transceiver 202 for sending and receiving packets to and from mobile devices in the vicinity of the PRD 200.

PRD 200 is equipped with transceiver 204 for sending and receiving information to the Central Controller 209. A wide variety of embodiments are possible. These include Ethernet, a separate WLAN radio, universal serial bus, or other wireless wide area wireless networking device using technology such as CDMA, GSM or long term evolution (LTE). Transceiver 204 connects to a communications network 207 such as the Internet over wired or wireless communications interface 206.

PRD 200 is equipped with permanent memory storage device 205 for storage of program instructions related to the operation of the proximity recognition system PRS. In various embodiments, this could include compact flash or similar memory devices.

PRD 200 processor 203 is configured to execute instructions stored in permanent memory device 205.

PRD 200 provides detection and recognition of wireless local area network (WLAN) enabled mobile devices in range of PRD 200 without a WLAN infrastructure. The ability to provide this capability is particularly important in venues that do not control WLAN infrastructure or do not wish to provide WLAN access for visitors for business reasons.

Proximity recognition device PRD 200 monitors WLAN communications at its known location determining the identifier of mobile devices in range within the venue during the mobile device's attempts to associate with a WLAN access point.

Proximity recognition device PRD 200 may optionally monitor multiple WLAN communications channels at its known location.

Based on a dynamically determined understanding of the WLAN infrastructure environment and WLAN infrastructure of interest to the mobile device 101, 1021103, proximity recognition device PRD 200 may prompt an association request from the mobile device by sending to the mobile device a specifically formatted response. To improve the mobile device location inference, more interactions are prompted by PRD 200. The prompted association request is preceded by management frames in the scanning and authentication phases of the association sequence.

Specifically, PRD 200 provides for detection of a WLAN association request received via antenna component 201 and wireless transceiver 202, wherein the association request is associated with a request originating from mobile device 101, 102, 103 to gain access to a wireless local area network.

The proximity of mobile device 101, 102, 103 is sensed by examining signal strength when the mobile device initiates a request for WLAN access.

A unique identifier of WLAN mobile device 101, 102, 103 may be provided in the association request. When provided, the unique identifier is provided to Central Controller 209 for further processing along with additional information such as PRD 200 identifier, signal strength and timestamp (herein, collectively, “Raw RSSI Data”). Central Controller 209 is coupled via communications interface 206 to the same communications network 207 as PRD 200 via communications interface 208.

In one embodiment, PRD 200 can also use permanent memory device 205 to temporarily record information regarding observations of mobile device operation until confirmation is received from Central Controller 209 that the information has been received by Central Controller 209.

With reference to FIG. 3, a block diagram of a typical venue environment into which a proximity recognition device (PRD) is deployed.

Within a typical deployment venue environment 300, PRDs 302, 308 may be connected to the venue's existing communications network 306. In various embodiments, PRDs 302, 308 may be connected to the venue's communications network 306 via some type of wired connection such as Ethernet 307 or wirelessly such as WLAN network 303 in venue 300. Venue's communication network 306 is attached by a communications interface such as DSL or cable modem 309 to wide area communications network 310 such as the Internet.

Within venue 300, a plurality of mobile devices 301, 304, 305 are expected to arrive and depart to and from venue 300 in a random nature. PRDs 302, 308 observe traffic from these mobile devices in its vicinity including their WLAN probe requests and WLAN association requests.

In the event a mobile device 301, 304, 305 associates with the venue's optional wireless local area network infrastructure (APs), the association request is observed by PRDs 302, 308 (including packets whose payload is encrypted using keys exchanged during the authentication phase of the association sequence).

In the event a mobile device 301 304, 305 signals to request access to WLAN infrastructure that PRD 302, 308 has observed to not be in the vicinity, PRDs 302, 308 may prompt mobile device 301, 304, 305 to proceed with an association request by sending to mobile device 301, 304, 305, a specifically formatted protocol data unit (i.e. a management frame in the preceding scanning and authentication phases) using information supplied by mobile device 301, 304, 305.

In either of these cases, the resulting association request is observed by the PRD and where available the mobile device identifier and other optional parameters (such as signal strength) are recorded by the proximity recognition system PRS.

PRDs 302, 308 reports information regarding mobile device observations on an event or periodic basis to central controller (not shown) of the proximity recognition system PRS via communications network 310 which in this described embodiment is coupled to the venue's communications network 306 by a communications interface 309.

With reference to FIG. 4, a block diagram depicts a more complex typical example venue environment into which the proximity recognition system PRS may be deployed.

Within a typical deployment venue environment 400, a plurality of PRD devices 401, 402, 403, 420, 421 may be required. With reference to the specific embodiment example depicted in FIG. 4, PRDs 401, 402, 403, 420, 421 may be connected to the venue's existing communications network 460. In various embodiments, PRD may be connected to the venue's communications network 460 via some type of wired connection such as Ethernet 411, 412, 413 or wirelessly such as WLAN network 430, 431. Venue's communication network 460 is attached by a communications interface such as DSL or cable modem 470 to wide area communications network 480 such as the Internet.

Within venue 400, a plurality of WLAN mobile devices 450, 451, 452, 453, 454 are expected to arrive and depart to and from venue 400 in a random nature. The PRD observes traffic from WLAN mobile devices in its vicinity including WLAN active probe requests and WLAN association requests.

In the event a mobile device is configured to associate with and proceeds to associate with the venue's optional wireless local area network infrastructure, the association request is observed by the all PRD 401, 402, 403, 420, 421 devices in range of the corresponding wireless transmission from the mobile device. For example, an association request from mobile device 452 may be received by PRDs 401, 402, 420, and 421 but not PRD 403.

In the event a mobile device 450, 451, 452, 453, 454 signals to request access to WLAN infrastructure that the PRD has observed to not be in the vicinity, one or more of PRDs 401, 402, 403, 420, 421 may prompt the mobile device to proceed toward association with a specifically formatted protocol data unit (PDU), being a management frame, using information supplied by the mobile device. Several embodiments of this network proximity technique are possible. One embodiment involves one or more of PRDs 401, 402, 403, 420, 421 sending a network Beacon PDU formatted with the SSID of the network requested by mobile device 450, 451, 452, 453 or 454. In another embodiment, one or more of PRDs 401, 402, 403, 420, 421 send a probe response PDU formatted with the SSID of the network requested by the mobile device. In another embodiment, one or more of PRDs 401, 402, 403, 420, 421 send a disassociation PDU formatted with the SSID of the network requested by the mobile device. One or more embodiments may be combined to provide the proximity recognition system PRS with more packets than normal, from the mobile device to improve the overall accuracy of mobile device location inference. The prompted association request is preceded by management frame messages in the scanning and/or authentication phases of the association sequence. The resulting association request (and pre-association request messages) are observed by all PRD devices in range of the corresponding wireless transmission from the mobile device. For example, an association request from mobile device 450 may be received by PRDs 402, 403, 420, and 421 but not PRD 401.

In either of these cases, the resulting association request is observed by the set of PRDs 401, 402, 403, 420, 421 and where available the WLAN mobile device identifier and other optional parameters such as signal strength, are recorded by the proximity recognition system PRS.

Each of PRDs 401, 402, and 403, 420, 421 deployed in venue 400 in the example embodiment depicted in FIG. 4, report information regarding mobile device observations on an event or periodic basis to central controller (not shown) of the proximity recognition system PRS via communications network 480 which, in this described embodiment, is coupled to venue's communications network 460 by communications interface 470. Based on the movement of the WLAN mobile device 450, 451, 452, 453, 454 through the venue, each PRD deployed within venue 400 will gain and lose visibility to association and related re-association transmissions from mobile devices 450, 451, 452, 453, 454. Each PRD 401, 402, 403, 420, 421 reports its observations to central controller (now shown). Based on information from each of the PRDs deployed within venue 400, the central controller is able to infer movement through venue 400.

With reference to FIG. 5, a block diagram illustrating the multi venue architecture of the proximity recognition system PRS is presented.

Central Controller 560 is connected to one or more venues 500, 510 by communications network 550 through communications interface 523. Communications interface 523 comprises one or some combination of cable modems, DSL, DS1, DS3, SONET, Ethernet, fiber optic, or some other future wired connectivity as well as WiMax, WiFi 802.11, Long Term Evolution (LTE) or some other current or future wireless technology in a manner well known to those skilled in the area of communications technology.

With exemplary venue 500, one or more proximity recognition devices PRDs 501, 502 are deployed in a manner designed to provide appropriate visibility of WLAN mobile devices within venue 500.

Proximity recognition devices PRDs 501, 502 within venue 500, as well as Proximity recognition devices PRDs 511 and 512 within venue 510 areconnected to communications network 550 through communications interfaces 521 and 522 respectively, as previously described. In one embodiment, PRDs 501, 502, for example, may be coupled to the communications infrastructure of venue 500 and communicate to communications network 550 through the venue's primary and possible back up communications interfaces 521 through some communications gateway 503 (with communications interface 522 and communications gateway 513 performing corresponding functions for PRDs 511, 513 within venue 510).

Central Controller 560 of the proximity recognition system PRS receives information from each of the proximity recognition device PRDs configured to send information to Central Controller 560.

In various embodiments, each PRD can send information to one or a plurality of central controller instances 560 for redundancy or information partitioning reasons.

With reference to FIG. 6, the architecture of a typical embodiment of central controller 600 of the proximity recognition system is depicted in accordance with the definitions provided above.

Central controller 600 includes one or more central processing units (CPU) 601 to execute instructions which are delivered or installed electronically (software) to central controller 600 such as a server program to manage the operation of system. Primary storage mechanism 620 is coupled to CPU 601 by interface 622 and is used to temporarily store instructions as well as to input and output data. CPU or CPU complex 601 is also coupled by interface 623 to other secondary storage medium 621 which is used to store information permanently even when central controller 600 is not powered. Information can include instructions and relevant information such as operational state data as well as configuration parameters.

For the purposes of system administration including system activity and status review, capacity optimization, or system configuration among other functions, graphic user interface (GUI) 611 of some form is optionally provided that connects with CPU 601 directly via local connectivity 604 or optionally via Network Interface 602. Optionally, Resource Manager 610 is connected to CPU 601 directly or via local connectivity 603 or optionally via Network Interface 602. Exemplary Resource Manager 610 entities that are commercially available include Splunk Enterprise and Hewlett Packard's Network Management Center product.

CPU complex 601 is also coupled by interface 605 to databases used to persistently store information about the status of the proximity recognition system PRS overall. Database 631 stores information about the venues registered with central controller 600 including some optimal combination of their name, contact information, security credentials, street address, global address expressed in latitude and longitude and possible site specific information. Database 632 stores information about the proximity recognition devices (PRDs) known to central controller 600 including some optimal combination of their name, communications and/or IP address, assigned venue, previously assigned venues, contact information, security credentials, and possible biometric information. Database 633 stores information about the mobile devices known to the instance of central controller 600 including some optimal combination of device identifier, venue appearance history as well as other possible device specific analytics information. Database 634 stores information about users registered with this instance of central controller 600 including name, user name, email address, company, venue access list, PRD access list, operational privilege list, account maintenance information, biometrics information, audit trail and possible security credentials. Database 635 stores information about analytics information awarded including some optimal combination of their venue summarization, device summarization, time of day, week, or month summarization, other historical data summarization or other forms of analytical calculation, date, time, customer identifier, merchant identifier, third party beneficiary identifier, transaction identifier, and possible security credentials.

Databases 631, 632, 633, 634, and 635 and other Secondary Storage Medium 621 are connected and configured for optimal systems operation in a manner well known to those skilled in the area of information systems and database technology.

Central controller 600 and in particular CPU 601, is also coupled via interface 606 to communications Network Interface 602 to communications network 550 as in FIG. 5 in a manner well known to those skilled in the area of information systems and communications technology.

With reference to FIG. 7, a flowchart describing the steps performed by the proximity recognition device PRD upon system start is depicted. In various embodiments, the PRD starts and becomes fully operational when power is applied or when certain time parameters are met (such as time of day, for example). Processing starts at step S7-1 and immediately proceeds to Step S7-2 in which the PRD establishes a connection with Central Controller.

Once connectivity has been established with Central Controller, certain information including time synchronization, is established at Step S7-3.

Proceeding to Step S7-4, the PRD waits to receive a WLAN protocol data unit (PDU) using antenna 201 and wireless transceiver 202 from WLAN mobile devices in the vicinity of the PRD.

When a PDU has been received at Step S7-5, the PRD proceeds to Step S7-6 in which the PDU is processed according to certain rules and instructions that have been delivered to the PRD. An example embodiment of PDU processing is described in FIG. 8.

After processing the received PDU, the PRD proceeds to Step S7-8 where the status of the PRD's synchronization with Central Controller is checked. If the PRD is synchronized with Central Controller, it returns to Step S7-4 and waits for another PDU to arrive from mobile devices within range of the PRD's antenna 201 and wireless transceiver 202.

At Step S7-8, if the PRD determines it is not synchronized with the central controller, the PRD proceeds to Step S7-7 where the PRD attempts to re-establish connection and synchronization with Central Controller.

With reference to FIG. 8, a flowchart describing the steps performed by the proximity recognition device (PRD) upon receipt of a protocol data unit (PDU) from a mobile device in the PRD's vicinity is depicted. Processing starts at S8-1 and immediately proceeds to S8-2 where the received PDU is analyzed.

Proceeding to Step S8-3, the PDU is examined to determine if the type of PDU is an association related PDU. If the PDU is association related, processing proceeds to Step S8-4, where the association related PDU is examined to determine if an identifier of the WLAN enabled client (which is typically a WLAN mobile device in the vicinity of the PRD) is available.

At Step S8-4, if the unique identifier for the WLAN mobile device is available, processing proceeds to Step S8-10 in which the PRD updates its knowledge of mobile device in its vicinity. This knowledge includes information such as WLAN mobile device identifier, observation time, signal strength, signal strength normalization information if available, and identifier of the access point AP to which the mobile device is requesting association.

Following Step S8-10, the PRD proceeds to step S8-11 where knowledge of access points APs known to be in the vicinity of the PRD is updated. This knowledge includes the unique identifier or MAC address of the access point AP to which the WLAN mobile device is requesting access, the assigned name of the access point AP, the related signal strength of the association, response time parameters and other possible unique elements of the access point AP or its response to the mobile device requesting association. If the unique identifier of the access point corresponds to the unique identifier of the PDU, the PDR also records this information.

Following Step S8-11, the PRD proceeds to step S8-12 in which the PRD determines if Central Controller is required. If required, the PRD sends update information as described above to Central Controller. Forms of update vary widely based on embodiment. Variations include compression techniques as well as security techniques. Compression possibilities include various compression methods include the Lempel-Ziv (LZ) compression method. Security possibilities include Message-Digest Algorithm variants include MD4 and MD4, Advanced Encryption Standard (AES) as well as various forms of public/private key encryption methods.

Returning to Step S8-3, if the PDU is not association related, the PDU is the examined at Step S8-5 to determine if it is a probe request from a WLAN device.

If the PDU is determined to be a probe request from a WLAN device at Step S8-5, the PDU is then examined at Step S8-6 to determine if the WLAN device/enabled client is probing for a named WLAN access point AP (as may be identified by its service set identifier (SSID) or some other similar identifier) that is known to be in the vicinity of the PRD.

If the PRD determines that the WLAN access point AP from which the WLAN enabled client is requesting a response is not in the vicinity, processing proceeds to Step S8-8 where the PRD determines if the WLAN enabled client is of interest to the PRD. Interest varies widely based on embodiment. Parameters that may be used to determine interest level include determination of device type from the identifier of the WLAN mobile device, recent activity from the identified mobile device, information about other WLAN devices in the vicinity of the PRD as well as other possible factors.

If the PRD determines that the WLAN device (typically mobile device) is of interest, the PRD then sends at Step S8-9 a PDU to the WLAN device to request association.

Returning to Step S8-5, if the PDU is determined to not be a probe request from a WLAN enabled client, the PDU is then examined to determine at S8-7 if it is a Beacon from an access point AP in the vicinity and, specifically, in range of the PRD. If this is the case, the PRD then updates its knowledge of access points APs in its vicinity and updates Central Controller if required as described above for Step S8-11 and Step S8-12.

Processing of the PDU is completed (S8-13) and the PRD waits for the next PDU to be received.

In view of the foregoing discussions pertaining to the flowchart illustrated in FIGS. 7 and 8, it is understood that such a system enables merchants and real estate operators to better understand the behavior of venue visitors, customers and potential customers equipped with WLAN enabled mobile devices in new ways not heretofore possible.

While this invention is described in its preferred embodiment with reference to WiFi, the principles of this invention are easily applicable (by an average person skilled in the art) to other, short range communications protocols (including, but not limited to, Bluetooth (IEEE 802.15.1-2002/2005), Passive RFID, and Active RFID. The principle, that a device may be prompted into more communication than normal (by sending more management frames), is applicable in this broader scope of wireless technologies. Furthermore, the principle finds great applicability to a wireless technology where devices communicate using a unique identifier (UUID), thus allowing for the harvesting of more communication data points (e.g. more signal strength readings) for better granularity and accuracy of proximity detection and recognition.

Building on the preceding, the inventions disclosed below increase the quantity and the quality of the received signal strength signals (RSSI) data to improve the granularity and accuracy of proximity recognition. These inventions recognize standard protocol primitives, and based thereon, creates, organizes and uses its data structures and primitives, such as Raw RSSI Data, Fingerprint and proto-fingerprint, Fingerprints List, Decloaked List and Popular Networks List. Although some standard protocol primitives are used (for examples, a WLAN Probe response and a WLAN Beacon), the PRS (and its PRD(s)) of the inventions are not WLAN infrastructure or any part thereof; and can, and do, operate independently of (or without) WLAN infrastructure in a venue. The PRS (and its PRD(s)) for a venue only very superficially resembles WLAN infrastructure (AP) but the PRS is totally devoted to enhancing proximity recognition of mobile devices in a venue, and the PRS does not participate in (although it may eavesdrop on) data communications attempted between WLAN devices in the venue and WLAN infrastructure.

Probe Requests.

There are two types of a WLAN device's Probe request. One type specifies particular WLAN infrastructure (particular AP or particular network SSID, for examples). The other type is broadcast and “open-minded” (i.e. unspecified and seeks a response from any WLAN in the vicinity). By analogy, these two types are, respectively, “Is Frank there?” and “Anyone there?”

Herein, the term “[Network Specified]” is typically the common name/identification (SSID) of a particular WLAN infrastructure AP and is found in the relevant field of a Probe request frame (or relevant field of other management frame or control or data frame). [Network Specified] could be the BSSID of an AP but such is relatively rare (but could be highly distinctive for this invention's fingerprinting purposes, explained below). Although SSID is a series of octets, as a practical matter, the vast majority of [Network Specified] are a series of string of human-readable characters (like “City of Oz Wi-Fi Network”) and herein, SSID is considered the common (i.e. informal, human-readable) name of a particular WLAN infrastructure network. [Network specified] comes from manual specification by the device user and/or the device's preferred networks list and/or the “hidden SSID” list (the latter two lists, if and as developed by software resident in the device, are indicative of the device/user's preferences for particular WLAN infrastructure; and are to be distinguished from Popular Networks List of this invention, as explained below). Herein, each [Network specified] has its Temporal Validity, as explained below.

MAC Address

A device's unique identifier is capable of a nuance, explained next.

The use of the physical address or “MAC address” of a mobile device is explained in IEEE 802 standards, in standards relying thereon (e.g. Wi-Fi Direct) and standards supporting therefor (such as EUI-48, MAC-48 and EUI-64). For example, Wi-Fi Direct (a device-to-device protocol) relies on the device's MAC address, probe requests and related IEEE 802 primitives. The “MAC address” of a device is understood to be its manufacturer's assigned, “burned-in”, physical address and represents its “true” identity. But there is sometimes an additional “MAC address” (or a “cloaked” identity in addition to its “true” identity), explained below.

Herein, every WLAN mobile device has its unique “identity” with a key part thereof, a unique “physical address”. Herein, the term “[MAC address]” (and which is sometimes herein shortened as [MAC] for economy of expression), is, in its generality, the address found in the source field of the management frames sent by a WLAN Device. In many common contexts, [MAC address] is the manufacturer's assigned, “burned in” “physical address” of the device. Herein, a distinction is kept between a “MAC address” that is “burned in” and one which is a (higher level software) “overlay” in a management frame's source field, sent by the device, explained next. The management frame itself indicates whether its “MAC address” is one or the other. For example, in an IEEE 802 implementation, there is a (U/L) bit that is settable. If set to indicate “U”, the address in the source field of a management frame, should be considered as universally administered and globally unique, OUI (Organizationally Unique Identifier) enforced. It represents (commonly understood) the device's (inherent) “physical address”. But if set to indicate “L”, an additional “address” is introduced into action and deployed, explained below.

The (U/L) bit can be set by the user, third party and/or the manufacturer of the device. Where “U” is set by the manufacturer, the [MAC] is assigned by the manufacturer but is governed by the use of its OUI. Where “L” is set by the user, third party or manufacturer, the [MAC] is assignable as they decide and unconstrained in their choice of the value of [MAC]; and so the address in the frame source field should be considered as locally generated without constraint or relationship to the “physical address” or to any universally administered address. In other words, when “L” is set, the device has always one, unique and persistent “MAC address” and potentially a second “MAC address”—(1) the intrinsic, persistent “physical address” and (2) if/when the device sends a management frame, there could be another address (impressed by and at a software level above the physical layer) that identifies the source of the sent frame, where the second, “software address”, has no necessary relationship with the first, persistent, “physical address”.

Herein, the term “[MAC]” simpliciter means that Device/[MAC] may be “U” or “L”, as the case may be (or respectively, “true” or “cloaked” identity, as the case may be).

Herein, the term “[MAC](U)” means the (U/L) bit is set to “universal” so that Device/[MAC](U) is a device whose “true” (“uncloaked”) identity is [MAC](U).

Herein, the term “[MAC](L)” means the (U/L) bit is set to “local”, i.e. the address is being locally administered (potentially for the purpose of “cloaking” the device's “true” identity as a privacy-enhancing measure). Thus Device/[MAC](L) is a “cloaked” device (and for which its “true” [MAC](U) is sought, as taught by the present invention). Such “cloaking” can be effected by scrambling, randomizing or otherwise obfuscating the [MAC] (periodically or a-periodically) conventionally. In other contexts, a device may be considered “cloaked” if it has a “hidden ESSID”. Herein, a device is considered “cloaked” if its (U/L) bit is set to “local” but that does not preclude the application of the inventive principles to a device that is cloaked in the “hidden ESSID” sense.

Raw RSSI Data

Raw RSSI Data is, for a venue's PRS (including one or more PRDs), the complete collection of RSSI readings (and/or other spectrally related information) and their associated reception time stamps at each PRD, and their respective Device/[MAC addresses] (e.g. of WI-FI probe requests or related management frames). Typical Raw RSSI Data entry has format of {source [MAC address]; RSSI reading; time stamp} (plus often fields for other useful information). The data is kept for applicable/tunable periods of time. The data is kept variously—including: in the entirety of their original condition or as processed into curated form (e.g. aggregated form, filtered or segregated or trimmed into subsets, parameterized by time and other factors, etc.). For ease of expression herein, the term “Raw RSSI Data” is used even when a processed, curated version is meant unless the context requires specificity.

Increasing the quantity and/or quality of data (for/of Raw RSSI Data) improves the granularity/accuracy of proximity recognition processes. This invention addresses both challenges.

Although herein, reference is made to the identity of a device as its “MAC address”, in fact, the principles are applicable to the equivalent of a “MAC address” in other protocols, wherein the identity of a device is set at a relatively low level (physical, hardware) but there is a mechanism, at a higher level, to allow the device user (or third party) to masquerade that identity as something else.

Although the preferred embodiments are described within the WLAN regime, the inventive principles disclosed herein are not thereby limited.

One principle (roughly abbreviated for illustrative purposes only) involves the identification of the true identity of a device that has been “cloaked” (e.g. its Probe request identifies its source as Device/[MAC](L)), by evaluating its history (recent or distant) of Probe requests for WLAN infrastructure, and inferring from that history, the Device's “true”, [MAC](U). What “something” has been interested in (and equivalently, what “someone” (the device user) has been interested in), is a good clue to its (his/her) identity. According to this invention, a “cloaked” Device/[MAC](L) is decloaked, and the spectral and other data originally related thereto, is re-attributed to its “true” Device/[MAC](U). This improves the quality of Raw RSSI Data by eliminating entries that appear to indicate two devices when only one is present in the venue.

Another principle (roughly abbreviated for illustrative purposes only) involves a device that is not articulate in its interests are (i.e. it sends a broadcast probe request instead of a unicast probe request that specifies an WLAN infrastructure network, [Network specified]), this invention teaches to offer the apparent presence of “popular” network(s) as a way of stimulating a reaction from the device, which reaction is the device's sending of further management frames, would thereby provide their respective [MAC](i.e. whether (U) or (L)) in their respective source address fields, and thus additionally nourishes Raw RSSI Data (explained below) with RSSI data entries that would not have occurred in normal WLAN communications. This improves the quantity of Raw RSSI Data.

Increasing Quantity of Data by Stimulating Traffic from Devices.

Three illustrative ways are disclosed below.

I. A PRD (upon observing a unicast Probe request with [Network specified]) sends a Probe response with source address as [Network specified]. An explanation and reference to FIG. 9(b), are made below. That [Network specified] is considered for inclusion in Popular Networks List.

II. A PRD (upon observing a broadcast probe request (i.e. without [Network specified]) sends Probe response(s) with source address(es) from Popular Networks List. An explanation and reference to FIG. 9(a) are made below.

III. A PRD (periodically or when discretely prompted by PRS/venue operator), sends a series of Beacons with respective source address from Popular Networks List.

These ways of increasing quantity of RSSI data will be explained after increasing quality of RSSI data is explained.

Increasing Quality of RSSI Data by Accurately Attributing Traffic to Devices.

Some devices are “cloaked” (as explained above). Decloaking a “cloaked” device, improves the granularity/accuracy of proximity recognition processes by attributing accurately RSSI readings to a single device where that single device had been cloaking its identity by presenting one or more “cloaked” identities and thereby giving the false impression of the presence of two devices.

Fingerprint (Basic Version)

It is conventional to consider a mobile device's physical or [MAC address] and/or its spectral characteristics and/or geographical attributes, as its unique identifier or “signature” or “fingerprint” (informally understood). Spectral characteristics include RSSI, frequency(ies), channel(s), modulation scheme characteristics and similar/related. Geographical attributes include its last known (e.g. GPS) geo-location(s). Attempts to combine, use and related, the information from cell phone traffic (e.g. SMS (short message services) messages) and from “social media” (e.g. Twitter® traffic), have been made.

Beyond the conventional, this invention teaches that a mobile device's (recent or distant) history of interests (e.g. Probe requests seeking [Specified networks]) is important as probative of its identity—that that history is a key part of “fingerprint”, especially if the conventional parts of its identity are compromised or are poorly/not available. Consider a whimsical restaurant analogy, for illustrative purposes only, where the kitchen backroom staff guesses that a particular customer is in the restaurant because a particular meal order has been sent to the kitchen (e.g. at 9 AM Monday, the order is for three scrambled eggs, four sausages and rattlesnake—flavor-tinged peanut butter on a toasted donut, such as has been ordered every Monday at 9 AM for the preceding month). Even if the kitchen staff does not see the customer in the restaurant's seating area, the kitchen staff reasonably infers the presence of that customer by “identifying” him by the (peculiar, even if not unique in the strict sense) particulars of the meal order.

Fingerprints List.

A single [Network Specified] is one fragment of the “real identity” of a mobile device that sent a unicast Probe request for that [Network Specified], and it is recognized and treated by this invention, and termed herein, as a (single) “fingerprint fragment”. Herein, the [Network Specified] of a Probe request of a device and the “fingerprint fragment” of a device, correspond to each other, the former in the WLAN regime and the latter in this invention's conceptualization of the former. A “fingerprint fragment” (and the Fingerprint and proto-fingerprint that are constructed therewith, as explained below) is one characteristic of a device that is useful for decloaking cloaked Devices/[MAC](L) (as explained below). Herein, a “fingerprint fragment” has its Temporal Validity, as explained below. For the venue's PRS (and its PRD(s), the Fingerprints List is a list of “fingerprint fragments” associated with each Device/[MAC address] (whether [MAC address](U) or [MAC address](L), as the case may be) that represent its history of [Network(s) specified], as observed (by the PRS/PRD(s)) in Probe requests from that Device/[MAC], and whose spectral and other information is recorded in Raw RSSI Data. Each entry of the Fingerprints List has its Temporal Validity, as explained below

Obviously, a single fingerprint fragment (i.e. a single [Network specified] from a single Probe request) is insufficient to characterize or identify a Device. It has insufficient history of that Device's Probe requests and related, for an identification. Sufficiency can be parameterized by several factors including the minimum number of unique fingerprint fragments received from that Device/[MAC]'s Probe requests, to qualify as its Fingerprint (herein, “Fingerprint Qualification Minimum”), with a Temporal Validity. If Fingerprints List for a Device/[MAC] has (at least) the Fingerprint Qualification Minimum “fingerprint fragments” (each fragment being a [Network specified]), the Device/[MAC] is considered herein to have a “Fingerprint”. Otherwise, the Device/[MAC] is considered to have a “proto-fingerprint” (i.e. at least one fingerprint fragment but less than Fingerprint Qualification Minimum). Given the particular dynamics of traffic in a venue, choice of time frame or Temporal Validity (i.e. how recent or distant past to measure any particular history of fingerprint fragments?) can be set by venue/PRS operator. Herein, each Fingerprint has its Temporal Validity, as explained below. When a “proto-fingerprint” achieves Fingerprint Qualification Minimum of fingerprint fragments, it becomes a Fingerprint of the Device/[MAC].

For illustration purposes only, Fingerprint Qualification Minimum” is three so when enough unique fragments (three) have been observed and recorded for a Device/[MAC], then it is justified to consider those fingerprint fragments/“proto-fingerprint” as a Fingerprint and to assign ownership of that set of “fingerprint fragments” as a Fingerprint to that Device/[MAC]. A Fingerprints List entry of {[MAC address (i)]} that has the Fingerprint Qualification Minimum (for that Device/[MAC(i)]) of fingerprint fragments or [Networks Specified], qualifies as a Fingerprint for that Device/[MAC(i)].

Herein, a [Network Specified] (in a Device's unicast Probe request) is considered to be a “fingerprint fragment” of that Device, and herein, a Fingerprint of a Device/[MAC address] is its list of (at least Fingerprint Qualification Minimum) fingerprint fragments (or {[Networks Specified]}). For example, if Fingerprint Qualification Minimum” is three, then the list of one or two unique fingerprint fragments associated with a Device/[MAC address] is kept in the Fingerprints List (herein, that Device/[MAC] is said to have a “proto-fingerprint”); and when, and only when, the third unique fingerprint fragment ([Network specified]) is added to that list, is that Device/[MAC] address considered to have a Fingerprint (being the list of three unique fingerprint fragments). Accordingly, perhaps some entries of Fingerprints List have achieved the status of Fingerprint (i.e. a Device/[MAC] has a Fingerprint) while other entries have not (i.e. a Device/[MAC] does not have a Fingerprint but has only a “proto-fingerprint”, to which may be added, upon detection later, additional fingerprint fragment(s) (i.e. [Network(s) specified]) but does not yet qualify as having a Fingerprint at the relevant point in time. Because each Fingerprint has its Temporary Validity (explained below), a Device/[MAC] may have, at one time, more than the Fingerprint Qualification Minimum fingerprint fragments (i.e. it obtains or retains its Fingerprint), and at another time, less than Fingerprint Qualification Minimum (i.e. it has only a proto-fingerprint).

A format of the Fingerprints List (with (i) entries) could be:

{[MAC address (i)]-{unique [Network Specified (j)]}, for each i and its temporal validity Temporal Validity, then j=1, 2, 3, etc., where [MAC address] is (U) or (L), as the case may be for the Probe request received. If or when j≧Fingerprint Qualification Minimum to be a Fingerprint, then the {unique [Network Specified (j)]} become as Fingerprint and so Device/[MAC(i)] has a Fingerprint.

After Device/[MAC]'s Probe request's [Network specified (j)] is received and is recorded in Fingerprints List as a fingerprint fragment for that Device/[MAC], the reception (within relevant Temporal Validity(ies)) of a Probe request with the same [Network Specified (j)], is ignored for the purpose of calculating whether a proto-fingerprint becomes a Fingerprint of that Device/[MAC address] or the purpose of adding that [Network specified] or fingerprint fragment to an existing Fingerprint.

As an illustrative example of Fingerprints List entries (for a given Temporal Validity):

1. [MAC address 1](U)-{[national Wi-Fi network 1], [Cafe Chain 1], [Mall 1], [home WLAN 1]}

2. [MAC address 2](U)-{[national Wi-Fi network 1], [Cafe Chain 1]}

3. [MAC address 3] (U)-{[national Wi-Fi network 1], [Cafe Chain 1], [Mall 1], [home WLAN 2]

4. [MAC address 4] (U)-{[national Wi-Fi network 1], [Cafe Chain 1], [Mall 1], [home WLAN 1], [Mall 2]}

5. [MAC address 5] (L)-{[national Wi-Fi network 1], [Cafe Chain 1], [Mall 1], [home WLAN 1]}

6. [MAC address 6] (L)-{[municipal Wi-Fi network 1]}, [Cafe Chain 1], [Mall 1], [home WLAN 1]}

7. [MAC address 7] (L)-{[municipal Wi-Fi network 1}, [Cafe Chain 1]}

For illustration purposes, consider the following scenarios (each taken separately, and not necessarily connected with each other except as explained).

Because the respective Fingerprints of entries nos. 1 and 5 are the same, it is inferred that a single, mobile device is implicated as the single source of frames which previously had been attributed to two devices. Entries in Raw RSSI Data has entries that were previously attributed to (Device/[MAC 1](U) and Device/)[MAC 5)](L) can now be attributed properly to Device/[MAC 1](U)). Because one of the compared two entries is for an uncloaked device, i.e. Device/[MAC 1](U), then Device of [MAC 5](L) has been decloaked as Device/[MAC 1](U). Accordingly, the Decloaked List will be updated (either in “real time” or periodically, explained elsewhere) by associating the relevant entries of Raw RSSI Data (and of other data structures/primitives derived therefrom) to properly associate with the single, true Device/[MAC], as explained below

The respective Fingerprints of entries nos. 4 and 5, are nearly identical (but are not identical because entry no. 4 has [Mall 2] that is not found in entry no. 5) at a given time of evaluation. And so for the time being, the inference that the same, single, mobile device is the source of the two Fingerprints, is unjustified. Later, Device/[MAC 5](L) might receive another fingerprint fragment, say [Mall 2] read from a Probe request, in which case, entries no. 4 and 5 match and Device/[MAC 5](L) is thereby decloaked as truly Device/[MAC 4](U).

Both entries nos. 2 or 7 (each having only two fingerprint fragments and less than Fingerprint Qualification Minimum of three to qualify as a Fingerprint) have their respective proto-fingerprint. If another probe request is later received from Device/[MAC 7](L), and its [Network specified] fragment is unique for that Device/[MAC 7](L), then at that future time, that unique fragment is added, so that entry no. 7 will have its Fingerprint and will be considered for decloaking calculations).

Entries nos. 1 and 6, both [MAC](L), have different Fingerprints (the difference being [national Wi-Fi network 1] compared with [municipal Wi-Fi network 1]). As part of trimming for decloaking purposes (explained below), those two fingerprint fragments may be ignored (for the narrow purpose of fingerprinting and decloaking) as being too common and adding nothing to the distinctiveness of their respective Fingerprints. If ignored (i.e. their β=0), then entries nos. 5 and 6 have the same Fingerprints and Device/[MAC 6](L) can be decloaked as Device/[MAC 1](L).

As indicated above, a Device/[MAC] and its status of having a Fingerprint or a proto-fingerprint, have a temporal aspect Temporal Validity. Although Raw RSSI Data may be kept in its original form permanently, each “fingerprint fragment” ([Network specified]) (and each data element based thereon (each Fingerprint and each “proto-fingerprint”) (all being derived from Raw RSSI Data), and each data structure that is based on the “fingerprint fragment” (i.e. “fingerprint fragment”, Fingerprint and “proto-fingerprint”) has, for a given purpose (e.g. decloaking), its respective temporary validity, parameterized by minimal essentials (including a start time with a duration, or simply an end time). For example, the start time may be relative (for examples, the start time is the time of receipt of the earliest unique fingerprint fragment for that [MAC address] or the time of receipt of the earliest unique fingerprint within a PRS system-wide time frame) or rolling window of time; or the start time may be an absolute PRS/PRD system-wide time; and the duration may be set as 10 minutes, to commence at that start time. For example, an end time may be a system-wide time such as midnight daily or the end of the business day of the business week or some other venue-specific end time.

The Temporal Validity is important for the purpose of certain calculations, explained below (e.g. decloaking and updating Raw RSSI Data and Decloaked List). When temporally invalid, the Fingerprint (or proto-fingerprint or fingerprint fragment) is not necessarily destroyed—it simply is not used for certain purposes. That start time can be scheduled in conjunction (or not) with other Device(s)/[MAC(s]] (whether [MAC](U) or [MAC](L)). For example, a PRS (and all PRDs/Fingerprints List) may be valid for decloaking calculation purposes, is valid for a 24 hour period, all starting at the same time. Or a PRD/Fingerprints List may vary from PRD to PRD in a PRS, or other variations.

The measure of “same Fingerprint” (and “unique Fringerprint”) above can be tuned (and sometimes relaxed) to meet venue business objectives, as explained below.

Decloaked List

The Decloaked List is an association of cloaked Device(s)/[MAC](L) to (single, “true”) Device/[MAC](U).

{[MAC address (i)}]/(U)←→[MAC address(es)(k)]/(L)}, k=1, 2, 3, etc.

The Decloaked List reflects the possibility (and in some scenarios, the likely reality) that a device may (periodically or aperiodically) cloak itself by generating and using a plurality of {[MAC](L)} to identify itself in its management frames. Once a Device/[MAC](L) has been uncloaked (as explained elsewhere), then every entry in Raw RSSI Data (both historical or in the future) that is attributed to a [MAC](L), will be re-attributed (for temporary, calculation purposes) to [MAC](U).

The Decloaked List is updated (by the decloaking process, described elsewhere) and is used simply as a look-up table—to find the “true” identity of Device/[MAC](L) and recalculate certain data structures and primitives that are derived from Raw RSSI Data.

The first way of increasing quantity of WLAN management traffic and thereby Raw RSSI Data, is explained. Reference is made to FIG. 9(b) and associated explanation below that is part of the general review of FIGS. 9(a) and 9(b).

The second way of increasing quantity of WLAN management traffic and thereby Raw RSSI Data, is explained with reference to FIG. 9(a) and Popular Networks List.

Popular Networks List

To address the “broadcast” probes received, the PRS (and its PRD(s)) respond by sending Probe responses which identify themselves with network names from Popular Networks List. Popular Networks List is a list kept by the PRS (and its PRD(s)) of Wi-Fi networks (identified by their common names or SSIDs) that are well-known and often sought (i.e. “popular”), preconfigured initially (by venue or PRS operator, based on, for example, general knowledge of the popular networks in the geographical region of the venue). For example, suppose Popular Networks List is set to have ten networks known by their common names or SSIDs. When a Probe request of the broadcast type is received by a PRD, then it will send ten Probe responses immediately (in a burst, one response immediately after the other, each response identifying its source with, respectively, one of SSIDs/[Network specified] from Popular Networks List (i.e. step S9-6 in FIG. 9(a)). Note that “popular” herein, is from the point of view of the PRS/PRD(s)—i.e. what networks have been frequently requested by mobile devices in the past, as an indicator of what likely will be requested in the future. In contrast, the “preferred” networks (of “preferred networks list” or “hidden SSID list”) is from the point of view of a mobile device (i.e. what that device has been historically interested in and specifically probed for). The Popular Networks List represents a “good guess” about what mobile devices are probing for. And in some implementations of cloaked devices, the effect of providing a favorable (i.e. sought and perhaps expected) Probe response to a Device, will be to trigger the Device to uncloak itself and revert to identifying itself with its true [MAC](U) (as explained below, this sense of “uncloak” is particular to the action of the Device, as an artifact of its implementation, and not to the “uncloak” otherwise described here).

The Popular Networks List can be updated in a formulaic, dynamic way. First, consider each [Network Specified] in unicast Probe requests as it is read by the PRS (and its PRD(s)), regardless of the cloaked or uncloaked status of the Device/[MAC] of the device that sent the Probe request, and consider for inclusion in (i.e. promotion to) the Popular Networks List. Each [Network Specified] ever read (from Probe requests or any other management or data frames), has an associated counter and timer that counts how often it has been read by the PRS (and its PRD(s)) within a prescribed time period Temporal Validity. Then, for example, if the frequency of receipt of a particular [Network Specified] or fingerprint fragment, exceeds a prescribed level in that period, then it has become, by definition, a “popular enough” network to be included in the Popular Networks List. Perhaps the prescribed level is the popularity of the least popular [Network specified] on the Popular Networks List, in which case the least popular [Network specified] therein, will be relegated out. Similarly, over a period, it might become evident that a particular [Network Specified] or fingerprint fragment on the Popular Networks List is “losing” popularity and should eventually be culled from Popular Networks List. This promotion and relegation is dynamically driven by formula which includes a (user-adjustable) period for evaluating the popularity of each [Network specified] received, whether on the Popular Networks List or not, at any given time. The Popular Networks List can be thought of as a dynamic “Top Ten” list of networks expected to be the subject of unicast Probe requests for the venue and PRS.

In one formulaic embodiment, the Popular Networks List may have certain entries which are initially reserved for configuration by the venue/PRS operator. For example, these reservations are preconfigured by operator with well known, national, regional, municipal/retail business Wi-Fi networks (for examples, Shaw Opens™, Starbucks™ and public transport system). The venue/PRS operator's knowledge of such popular networks is a matter of objective consideration based on public knowledge or inferences thereof. But even these preconfigured [Networks specified] may lose “popularity” over a period and ultimately be relegated from Popular Networks List. Note that the purpose of the Popular Networks List relates to stimulating more management frames traffic for better granularity and accuracy of proximity recognition, especially when facing an open broadcast Probe request, and is not related to fingerprinting for the purpose of decloaking “cloaked devices”, explained elsewhere. A popular network may be of great value for the former purpose but of little or no probative value in the latter for “fingerprinting” a device.

In FIGS. 9(a) and 9(b), steps S9-6 and S9-16 thereof, are similar, except that S9-16 sends a single probe response with source=[Network Specified] (from S9-10) whereas S9-6 sends a plurality of Probe responses, each response with a source address from Popular Networks List. After S9-6 or S9-16 and the stimulation effected, the PRD waits and listens for management frames from the mobile device that were stimulated, and gathers RSSI and other related data therefrom. Such increase of Raw RSSI Data (i.e. with Device management frames that would not otherwise exist in a normally operating communications WLAN network with Device) provides more granular and accurate proximity recognition.

The third way of increasing quantity of WLAN management traffic and thereby Raw RSSI Data, is explained with reference to a WLAN Beacon. The PRD sends a Beacon with source from Popular Networks List (and other (guessed) information in compliance with protocol), such as supported rates, modulation parameters set, etc.)—get back device's probe request (to obtain RSSI readings).

Curating or Trimming Data

In FIGS. 9(a) and 9(b), the concept of trimming is illustrated as located in various locations in the flowcharts to indicate stylistically the various points where trimming might be advantageous (especially to improve the quality of RSSI data for further calculation purposes). Herein, the term “Trim” (and derivative terminology) is a conceptual technique to ignore certain entries of Raw RSSI Data for certain purposes and calculations (as being unlikely trustworthy or unlikely probative of distinctiveness for fingerprinting, for examples). Three themes for trimming are explained next.

1. Trim Likely Untrustworthy Data

If two fingerprint fragments (from their respective Probe requests) are concurrently received by a PRD—whether the same [Network Specified] is received concurrently from more than one “true” Device/[MAC](U), or ii) same [Network Specified] is received concurrently from more than one “cloaked” Device/[MAC](L)), then it may be prudent to ignore the RSSI data of the Probe Requests of one or both Devices. As an example for illustration purposes only, suppose twin sisters walk together, each with her own mobile device, in the mall venue, and their shopping interests, in particular, and their daily dynamics, generally, are identical. The expectation of successfully decloaking individually each sister's Device at the mall venue, is almost infeasible. So it is better to ignore one (or both) sets of RSSI data.

The above scenario can be distilled with some temporal primitives as follows.

Device/[MAC 1] window1 (with start time1 and extending duration D)

Device/[MAC 2] window2 (with start time2 and extending duration D)

Assuming (for simplicity) same duration D for both devices, start time2 is relatable to start time1 and duration D, e.g. start time2 is set to be start time1 or soon thereafter but obviously not past duration D.

The concept of “concurrency” is made practical by comparing window 1 and window 2 and setting the length of temporal overlap, as “concurrent” for the purpose of ignoring one or both two devices in respect of their respective RSSI data of their respective Probe requests.

2. Do not compare two Fingerprints (for the purpose of Fingerprint matching and decloaking) where their respectiveTemporal Validity do not share a minimum overlap of time (such temporal overlap is adjustable by venue/PRS operator)—less than the minimum overlap (or no overlap at all) implicates the risk that a match is untrustworthy.

3. Ignore a fingerprint fragment with likely no or little probative value.

Certain [Network specified] or fingerprint fragments are trimmed (by ignoring), as pre-configured by the venue/system operator as being “too common” to be worth counting because they have little or no “uniqueness” attributes or are inherently of no interest for a given purpose or calculation. For example, the Fingerprint of [Networks specified] of <national Wi-Fi Network, Mall Wi-Fi network, public transit Wi-Fi network> is typical of so many individuals/devices in a certain geographical area where the venue/PRS is located, and so can be ignored for purposes of fingerprinting and decloaking. Furthermore, the mobile devices of venue cleaning staff, administrative staff, security staff and the like, are inherently not of venue mall shopping visitors and so any Fingerprints developed for them can be ignored for decloaking purposes (or all WLAN frames from such personnel's Devices/[MAC] can be preconfigured by venue/PRS operator, to be ignored). Common “fingerprint fragments” are worthy to be considered for the updating of Popular Networks List but unworthy to be part of fingerprinting for decloaking purposes.

A “trim” does not necessarily implicate the deletion of certain entries of Raw RSSI Data. Typically, a trim means that certain data entries are ignored for certain purposes and calculations. It is advantageous to keep Raw RSSI Data in its original, complete condition for subsequent review and global recalculations (e.g. by venue/PRS operator adjusting the Temporal Validity of a particular data structure/primitive, as explained below—e.g. change Fingerprint Qualification Minimum to qualify as a Fingerprint).

Periodic Update of (System Wide) Raw RSSI Data and/or Data Structures/Primitives Derived Therefrom

The flowcharts of FIGS. 9(a) and 9(b) show the (“real time” or near-“real time”) processing of a Probe request after reception by a PRD. Some processing on a system-wide (i.e. on the entirety of Raw RSSI Data) is performed periodically (as stylistically indicated as operating in the “background” of those “real time” flowcharts, to update the Raw RSSI Data and/or selected portions (e.g. Decloaked List)), advantageously for subsequent reception and processing of Probe requests. The period of this potentially large scale, system-wide updating can be short (e.g. every 10 minutes or be based on the predicted cloaking behavior of particular brands of mobile device and/or hardware/software technology, based on general industry averages—e.g. the period of cloaking (and re-cloaking) of [MAC address] (e.g. from one [MAC](L1) to another, [MAC](L2)) as estimated for such branded devices). The period of updating can be longer (e.g. every 24 hours, after the close of business in retail mall venues). The period is set by the venue/PRS operator according to venue dynamics business purposes (e.g. for the holiday shopping season). The period of updating can be a “rolling window” (of tunable/parameterized duration) so that the “Raw RSSI Data” is processed and results considered.

On the “uncloaking” of a cloaked device, the Fingerprints List is updated by associating that Device/[MAC](L) entry (of Fingerprint or proto-fingerprint) with its “real” [MAC Address](U), which in turn will update the Decloaked List. Then Raw RSSI Data (or a temporary version thereof) may be supdated so that the RSSI readings of cloaked devices/[MAC]/(L), are “re-associated” with their “true” [MAC addresses]/(U). This may result in the “compression” of a plurality of readings into a small set of readings, and a reduction of the number of mobile devices detected over the same period of time (because two sets of readings are for the same mobile device). As the size of the window is changed, and rolled forward, it may be that earlier compressions of readings are reversed and the result is an expansion of data points as indicative of more Devices/[MAC addresses], etc.

Next is an overview of the flowcharts of FIGS. 9(a) and 9(b).

The PRD reads the mobile device's Probe request's [MAC]. With reference to FIGS. 9(a) and 9(b), the type of probe is determined—a broadcast (seeking any WLAN infrastructure) or unicast (for a specified network) (S9-1).

If the Probe request is a broadcast type (FIG. 9(a)), then is the Device/[MAC] on the Fingerprints List? (S9-2) If not on the Fingerprints List, then make an entry for this Device/[MAC] in Fingerprints List (S9-7) and proceed to send Probe responses (with source addresses taken from the Popular Networks List) (S9-6). If on the Fingerprints List, determine if the Device is cloaked (i.e. is it a [MAC](L)?) (S9-3). If not cloaked, then proceed to send Probe responses from Popular Networks List (S9-6) using [MAC](U) (as destination address). If cloaked, then determine if the Device/[MAC](L) is on the Decloaked List (S9-4)—in other words, has this Device/[MAC](L) been previously decloaked? If previously decloaked, then obtain from the Decloaked List the (“true”) [MAC](U) and use it (as destination address) in sending the Probe Responses from Popular Networks List (S9-5, S9-6). If the Device/[MAC](L) is not on the Decloaked List (S9-4), Probe responses are sent using [MAC](L) (as destination address) (S9-6). The sending of Probe responses (S9-6) includes sending a plurality of probe responses (in rapid succession) where each probe response identifying itself as coming from one of a Popular Networks List, and addressed to (i.e. destination address) being the [MAC] of the Probe request, where [MAC] is the probe's [MAC](U) (as it was always or as uncloaked by then) or is the probe request's [MAC](L) (if still the uncloaked). If the effect of the (S9-6) plurality of Probe responses may be that one of the networks in Popular Networks List was sought by the Device, and depending on the configuration of the Device, it may revert to its [MAC](U), in which case, if the flow is from S9-5, the responses are to [MAC](U). The explanation is similar for S9-16 in FIG. 9(b).

If the Probe request is a unicast type with a [Network specified] (FIG. 9(b)), then the Popular Networks List is updated therewith (S9-8). More particularly, there is a formulaic promotion and relegation dynamic for the Popular Networks List (as explained below). The formulaic consideration of the just read [Network specified] and considering whether to promote (or not) it, constitutes the updating of Popular Networks List (S9-8). Then, is the Device/[MAC] on the Fingerprints List (S9-9)? If the Device/[MAC] is on the Fingerprints List, then proceed to update with [Network specified] (S9-10). If the Device/[MAC] is not on the Fingerprints List, then enter that Device/[MAC] into Fingerprints List for this Device/[MAC] (S9-11) and then add [Network specified] as part of its proto-fingerprint or Fingerprint (S9-10). In either case, the Fingerprints List for the Device/[MAC] with the fingerprint fragment ([Network specified]) of the Device/[MAC] (S9-10).

Next, does this Device/[MAC] have a Fingerprint (S9-12)?—perhaps it does with the just received/added fingerprint fragment ([Network specified]) or perhaps it is still only a proto-fingerprint because it has less than Fingerprint Qualification Minimum to qualify as a Fingerprint. If this Device/[MAC] does not have a Fingerprint, proceed to S9-16 to send a Probe response with source=[Network specified] (Cloaked or uncloaked, as the case may be). If this Device/[MAC] has a Fingerprint, compare it to all of the other Fingerprints in Fingerprints List (S9-13). If unique (i.e. no match), then proceed to S9-16 to send a Probe response with source=[Network specified]. If not unique, then that Fingerprint is one of the two identical Fingerprints and so consider if one of the two is for an uncloaked Device/[MAC](U)? (S9-14). If not (i.e. if both Fingerprints are for cloaked devices Devices/[MAC](L)), then proceed to S9-16 (to send a Probe response with source=[Network specified], and destination=Device/[MAC] (as read initially at S9-1 and S9-8). If one of the two identical Fingerprint is for an uncloaked Device/[MAC](U), and the other is for cloaked Device/[MAC](L), then the cloaked Device/[MAC](L)) has been decloaked (i.e. the same mobile device has been sending the same set of unicast Probe requests)—so update the Decloaked List (and concurrently or later, recalculate the Raw RSSI Data, changing the association of data readings from [MAC](L) with [MAC](U) (S9-15) (this “real time” change” is distinguished from the periodic, system-wide updating described elsewhere); and proceed (S9-16) to send a Probe response with source=[Network specified] addressed to Probe response's Device/[MAC] (U or L, as the case may be).

If the mobile device software implementation is that when it is cloaked (i.e. sending management frames with source=Device/[MAC](L)), and sends a unicast [Network specified] Probe request (perhaps from its preferred networks list), and then receives a Probe response that is favorable (i.e. one whose source is identified as the [Network specified] that is specified in its Probe request), it will decloak itself by reverting to using its Device/[MAC](U)) when sending further management, control or data frames. Thus the effect of sending a plurality of Probe responses from the Popular Networks List, may be to trigger (such an implemented) Device to decloak itself, in which case henceforth, there is the additional benefit of more accurate reading of its management (and subsequent) frames, and the PRD's Probe responses (whether from Popular Networks List or whether the last Probe request from that Device) will generate additional traffic for improvement of granularity of proximity recognition.

Fingerprint (More General Version)

A more general version of Fingerprint reflects its composite fragments which are themselves each individually distinctive to varying degrees. Each fingerprint fragment can be weighted according to their distinctiveness (whether considered historically for that PRS/PRD, or considered generally (not necessarily tied to that PRS/PRD)). Similar to the distinctiveness of a mark for trademark purposes, the spectrum of distinctiveness of a Fingerprint ranges from “generic” (or “too common”) to “highly distinctive”, as the result of the same consideration of each of its composite fragments. Thus, in deciding the degree of “match” (or not) between two Fingerprints, the matching formula considers weighted fingerprint fragments.

To reflect the distinctiveness of each fingerprint fragment and the distinctiveness of the Fingerprint compose of such fragments, in a generalization of the exemplary Fingerprints described above, a Fingerprint of a Device/[MAC] includes (beyond conventional spectral indicators (like RSSI data) and/or last known geo-location(s)) is the its list of fingerprint fragments and their associated weighting. In other words, each fingerprint fragment is of the format of (β(j)×fingerprint fragment (j)), with β≧0. Each β is associated with its fingerprint fragment or [Network specified] (whether upon receipt by the PRD or by central controller) based on consideration of its distinctiveness (the more distinctive, the higher β), as explained below.

An illustrative example of format of an entry in Fingerprints List is:

Device/[MAC address 1](U or L)−{β1×[national Wi-Fi network 1], β2×[Cafe Chain 1], β3×[Mall 1], β4×[Home WLAN 1] }

Consider some examples of weighting factor β devised for illustrative purposes only. Suppose [Home WLAN 1] has never been seen before Temporal Validity by this PRD/PRS and/or is inherently unlikely to be common. For example, that fingerprint fragment is peculiar to a device user's personal situation, such as a distinctive derivation of a rare family name, such as OF ATILLA-THE-HUN″, in which case a very large β4 (relative to the β-weights assigned to other fingerprint fragments) is set/calculated and assigned to that fingerprint fragment. For another (relatively uncommon) example, if the [Network specified] fingerprint fragment is a BSSID (i.e. the [MAC address] in octet format of a particular AP), then a very large β is appropriate. At the other end of the distinctiveness spectrum, [national Wi-Fi network 1] may be so popular as to be nearly ubiquitous and so would contribute virtually nothing to the distinctiveness of any resulting Fingerprint. In that case, β1 is appropriately assigned a relatively low value (or even β1=0 for some variations of the matching algorithm, explained below).

As an example, above scenario for Entries Nos. 5 and 6 where β1=0 for the (too) common fingerprint fragment of a national Wi-Fi network for the purpose of fingerprint-decloaking. Thus if two Fingerprints (one for [MAC](U) and the other for [MAC]((L)) share one fingerprint fragment that has one a very large 13, then the formula to determine a “match” or not, should be formulaically driven to conclude there is a match, regardless of the other fingerprint fragments (which would have much relatively smaller βs, even if they share no other fingerprint fragments).

One example of a matching formula that incorporates the distinctiveness of Fingerprints (i.e. to decide whether cloaked Device/[MAC x](L) is really Device/[MAC y](U)), a comparison is made between:

Device/[MAC x](U)'s Fingerprint of Σβ(m)×fingerprint fragment (m))

Device/[MAC y](L)'s Fingerprint of Σβ(n)×fingerprint fragment (n))

where fingerprint fragment (k)=fingerprint fragment (l) for at least one m and one n (otherwise, no comparison is made). In other words, at least one [Specified network] (or fingerprint fragment) of one Device/[MAC], is the same as one [Specified network] (or fingerprint fragment) of the other Device/[MAC]; otherwise, no comparison is made.

Then a comparison can be performed for conclusions (of match, no match, nea-match) in several ways (depending on venue business objectives).

The conclusion of a match of the above Fingerprints can be the strict arithmetic equality of above two formulas. In other words, compare:

Device/[MAC x](U)'s Fingerprint of Σβ(k)×fingerprint fragment (k))

Device/[MAC y](L)'s Fingerprint of Σβ(l)×fingerprint fragment (l))

On a fragment by fragment basis—is Device/[MAC x](U)'s β(k)×fingerprint fragment (k)=Device/[MAC y](L)'s β(k)×fingerprint fragment (k) for each k. If so, the sum for both Fingerprints will be the same. This exact identity on a fragment-by-fragment basis, is the strictest formula for deciding “same Fingerprint”. The formula can be relaxed in cases of a common, large, β, in which case, the two Fingerprints's Σ need only be “close” but not identical for a conclusion of a match, or, in a fragment-by-fragment comparison, only the fragments with the highest are considered for comparison. For example:

Device/[MAC 1](U)'s Fingerprint—{0.5×fingerprint fragment (1)); 100×fingerprint fragment (2); 1×fingerprint fragment (3)}

Device/[MAC 1](L)'s Fingerprint—{100×fingerprint fragment (2)); 2×fingerprint fragment (4); 1×fingerprint fragment (3)}

There is no match of these two Fingerprints on a fragment-by-fragment basis or on a Σ basis. But fingerprint fragment (2) with β of (relatively very large) 100, is shared by both Devices' Fingerprints and represents the “distinctive” fragment of both Fingerprints. With such an appropriate β for fingerprint fragment (2), an appropriate matching formula could conclude that (on either basis (fragment-by-fragment or Σ)), the two Fingerprints are “close enough” to conclude there is a match (and so Device/[MAC 1](L) will thereby be “decloaked” as Device/[MAC 1](U)) or “near enough” to rate being a “suspicious candidate” to prompt further forensic sleuthing (perhaps by tuning the Temporal Validity of other primitives in Raw RSSI Data and recalculating appropriate, or supplementing by other information sources, such as, video of physically and temporally proximate scenes).

For example, a shoplifter at a mall cloaks his Device when prowling and stealing but if he had been present before or after with his Device uncloaked, then the recognition that his Device/[MAC](L) is suspicious, can be coupled with insight from Raw RSSI Data with more expansive Temporal Validity and/or with video data that can conclusively identify the thief (whether by his RF fingerprint and/or visual (facial) features)).

Temporal Aspects, Including Temporal Validity

There are temporal aspects to many of the above-described data primitives and structures, i.e. they are valid for only for a specific purpose or calculation and only for a specific time frame. And they are adjustable or tunable by the PRS operator. For economy of expression, many of these temporal aspects are encapsulated by the term “Temporal Validity”, which is a conceptual term, as exemplified by the following explanations.

Because of the interrelatedness of many of the data structures and primitives, the Temporal Validity of one structure/primitive is a factor in the Temporal Validity of another structure/primitive, whether the relationship is a necessarily decisive factor, or one of several factors, and in any case, the relationship is (PRS-operator) adjustable.

As an example of a necessarily decisive factor that could have cascading or nested consequences, consider that each fingerprint fragment (i.e. [Network specified] on a per PRD basis) has its Temporal Validity (of start time and duration); that each entry of the Fingerprints List—i.e. Device/[MAC]'s list of fingerprint fragments (whether “proto-fingerprint” or Fingerprint)) has its Temporal Validity (of start time and duration); and that each Device/[MAC]'s Fingerprint has its Temporal Validity. When a fingerprint fragment reaches its Temporal Validity, i.e. it is no longer valid and is considered expired, then the validity of the Device/[MAC]'s list of fingerprint fragments that has that expired fingerprint, has to be reconsidered for its validity, and similarly the validity of the Device/[MAC]'s Fingerprint built from such expired fingerprint fragment, must be reconsidered.

As another example of a data structure/primitive that has Temporal Validity, consider the popularity of a [Network specified] for purposes of promotion to, or relegation from, Popular Networks List. What is the temporal measure for calculating popularity? During the preceding hour, day, week or month?—i.e. measure how far back to count “popular” or not? These questions are answered by PRS/venue operator and adjustments are made to Temporal Validity of relevant data structures and primitives. Thus each [Network specified], as explained above, has an associated counter (how often it has been specified?) and counter (the Temporal Validity). The specificity can be measured per PRD or all the PRDs in a PRS or across several PRSs (e.g. a plurality of mall venues) or nationally (according to national metrics for national Wi-Fi networks).

Another example of a primitive that has Temporal Validity is in the trimming techniques. As explained above, when two Probe requests are received “concurrently”, that calculation depends on a host of temporal aspects, including the Temporal Validity of the each Probe request.

Another example is the consideration of whether a Fingerprint is unique (i.e. when deciding whether two Fingerprints match) (S9-13). Each Fingerprint has its Temporal Validity so how much identity (or how much near-identity) of respective Temporal Validity of the two Fingerprints is required (or acceptable) for a valid comparison between them? These are adjustable by PRS/venue operator based on venue business objectives.

For example, the longer the Temporal Validity of a Device/[MAC](L) is, the more opportunities that it will be decloaked as a Device/[MAC](U). But the longer the Temporal Validity of a Device/[MAC](L) is, the more opportunities that the Fingerprint of Device/[MAC](L) and the Fingerprints of other Devices/[MACs](U) will increase in respective sizes, and reduce the likelihood of finding a match to decloak that Device/[MAC](L). This type of dynamic can be controlled with a more generalized version of a Fingerprint (using a weighting factor for each fingerprint fragment, explained above).

Calculation of Weighting Factor βs

The calculation and assignment of the appropriate weighting factor β to a fingerprint fragment (whether performed by the PRD or Central Controller in communication with the PRD, on receipt of the relevant Probe request or later). The β factor (for a [Network specified] or fingerprint fragment) is calculated on its distinctiveness based on where it is on the spectrum from “relatively common” (if not “generic”) to “relatively uncommon” (if not singularly rare), and an integral part of “relatively” is the time period of measurement (e.g. distinctive (increasing or decreasing) over the last week, last month, last year). In other words, distinctiveness has its Temporal Validity for fingerprinting purposes. Additionally, distinctiveness of a fingerprint fragment has its geographical aspect (e.g. distinctive (increasing or decreasing) in respect of the venue/PRS, or a larger area or in respect of similar venues/PRS). Tune each β—in part based on PRD's history Temporal Validity (or generally).

Also, the setting of Fingerprint Qualification Minimum of fingerprint fragments to qualify as a Fingerprint, can be changed (e.g. during a periodic system-wide update of Raw RSSI Data and data structures derived therefrom). Fingerprint Qualification Minimum can be changed (decremented, for example), if not enough Fingerprint matches and decloaking of devices, is occurring (because for example, the resulting overall count of venue mall visitors is too high at the end of the business day—this may occur if the setting of the values of βs is inappropriate for fingerprint fragments. So some proto-fingerprints may become Fingerprints with the smaller Fingerprint Qualification Minimum, for the purpose of comparing Fingerprints for decloaking purposes, and more decloaking will likely occur and the overall venue mall visitor count will decrease to a more realistic level.

Minimum qualifications for a proto-fingerprint to be considered a Fingerprint (for the purpose of finding matches with other Fingerprints)—minimum number of fingerprint fragments and a minimum value of large β (whether absolute size or relative to the other βs for a Device/[MAC))

The Popular Networks List has an approximately opposite look than the Fingerprinting. For example, a high 13 for a [Network specified] for purposes of fingerprinting (it is very distinctive) means that that [Network specified] is likely not on the Popular Networks List (and vice versa, a [Network specified] on the Popular Networks List likely has a low β for fingerprinting purposes).

Popular Networks List is valid for a PRD (or across all PRDs of a PRS) and likely has a Temporal Validity that is temporally more persistent (i.e. longer) than the Temporary Validities of the PRDs and constituent parts such as Fingerprints and fingerprint fragments

Although the above explanations are based on the WLAN Probe request and its source address and destination address (i.e. respectively, Device/[MAC] and [Network specified]), the inventive principles are (to varying degrees and with modifications within the competency of the average worker in the art) applicable to subsequent WLAN management frames (for examples, authentication requests, association requests, de-association requests) and to WLAN control and data frames, each of them having a [MAC] (whether (U) or (L)). For example, the Fingerprints List entry for a Device/[MAC] may be populated initially with the fingerprint fragment of a Probe Response and subsequently populated by that Device/[MAC]'s other management frames and then control or data frames. Or, for another example, the Fingerprints List entry for a Device/[MAC] may be populated initially with the fingerprint fragment of an Authentication request.

Venue business objectives may be loss prevention, enhancement of loyalty of mall customers/visitors, accuracy of number of unique visitors, accuracy of visitor ambulatory paths, etc. Depending on the objectives, there are several adjustable parameters explained above to attempt to satisfy the objectives. In the least, pro-active loss prevention implicates a review of historical Raw RSSI Data in a program or forensic sleuthing to identify a “suspicious” Device/[MAC] that was present in the time frame when retail losses were suffered, and that requires tuning the various Temporal Validity until candidate suspects are noticed.

1. A method of increasing the quantity of frames sent by a WLAN mobile device that has sent a probe request, in a venue, comprising the steps of:
a) developing a list of WLAN network SSIDs that are popular in that venue;
b) reading a probe request from the device;
c) if the probe request is a unicast probe request for a specified network SSID, sending a probe response with the source being the value of said specified network SSID; and
d) if the probe request is a broadcast probe request without a specified network SSID, sending a plurality of probe responses with respective sources being the network SSIDs from said list of popular network SSIDs.

2. A system for increasing the quantity of frames sent by a WLAN mobile device that has sent a probe request, in a venue, comprising:
a) a list of WLAN network SSIDs that are popular in that venue;
b) a reader that read the probe request; and
c) a transmitter that sends a probe response with the source being the value of said specified network SSID, if the probe request is a unicast probe request for a specified network SSID; and
d) a transmitter that sends a plurality of probe responses with respective sources being the network SSIDs from said list of popular network SSIDs.

3. A method of decloaking a WLAN device that has sent a frame with the source address being locally administered, comprising the steps of:
a) reading and recording a plurality of frames sent;
b) for a first device with a universally administered source address, recording and compiling a list of each unique specified network SSID of each frame that specified;
c) for a second device with a locally administered source address, recording and compiling a list of each unique specified network SSID of each frame that specified;
d) comparing said first device list and said second device list to determine a match;
e) deciding that said second device is said first device if there is a match of lists.

4. A system of decloaking a WLAN device that has sent a frame with the source address being locally administered, comprising:
a) a reader that reads a plurality of frames sent and a recorder that records them;
b) for a first device with a universally administered source address, the recorder compiles a list of each unique specified network SSID of each frame that specified;
c) for a second device with a locally administered source address, the recorder compiles a list of each unique specified network SSID of each frame that specified;
d) a comparator that compares said first device list and said second device list to determine a match;
e) a decision maker that decides that said second device is said first device if there is a match of lists.
